(19) United States
(12) Patent Application Publication
(10) Pub. No.: US 2016/0277457 A9
(43) Pub. Date: Sep. 22, 2016

(54) MULTI-GROUP METHODS AND SYSTEMS FOR REAL-TIME MULTI-TIER COLLABORATIVE INTELLIGENCE

(71) Applicant: Unanimous A.l. LLC, Pismo Beach, CA (US)

(72) Inventor: Louis B. Rosenberg, San Luis Obispo, CA (US)

(21) Appl. No.: 14/708,038

(22) Filed: May 8, 2015

Related U.S. Application Data
(63) Continuation-in-part of application No. 14/668,970, filed on Mar. 25, 2015.
(60) Provisional application No. 61/991,505, filed on May 10, 2014.
(60) Provisional application No. 61/970,885, filed on Mar. 26, 2014.

(51) Int. Cl. H04L 29/06; H04L 29/08; G06F 3/0484

(52) U.S. Cl. CPC H04L 65/403; G06F 3/0484; H04L 67/10

(57) ABSTRACT

Systems and methods for deriving a real-time closed-loop collaborative intelligence from a plurality of users of a plurality of computing devices, the computing devices in communication with a central server. In some embodiments, a multi-level collaborative system divides the portable device users into groups, with one group providing feedback to another group. In other embodiments, a multi-tier system is used to designate multiple host devices in lieu of the central server. In some embodiments, the central server is used with a plurality of the multi-tier systems. Input methods for collaborative target selection and rating of group collaborative responses are also disclosed.

This application claims the benefit of U.S. Provisional Application No. 61/991,505 entitled METHODS AND SYSTEM FOR MULTI-TIER COLLABORATIVE INTELLIGENCE, filed May 10, 2014, which is incorporated in its entirety herein by reference.

This application relates to methods and systems for real-time closed-loop collaborative intelligence described in the following application. The related application, which is incorporated herein by reference, is:

U.S. patent application Ser. No. 14/668,970 of Louis B. Rosenberg; entitled METHODS AND SYSTEMS FOR REAL-TIME CLOSED-LOOP COLLABORATIVE INTELLIGENCE.

### BACKGROUND OF THE INVENTION

1. Field of the Invention

The present invention relates generally to systems and methods for group collaboration, and more specifically to systems and methods for closed-loop, dynamic group collaboration.

2. Discussion of the Related Art

Portable computing devices, such as cell phones, personal digital assistants, and portable media players have become popular personal devices due to their highly portable nature, their ability to provide accessibility to a large library of stored media files, their interconnectivity with existing computer networks, and their ability to pass information to other portable computing devices and/or to centralized servers through phone networks, wireless networks and/or through local spontaneous networks such as Bluetooth® networks. Many of these devices also provide the ability to store and display media, such as songs, videos, podcasts, ebooks, maps, and other related content and/or programming. Many of these devices are also used as navigation tools, including GPS functionality. Many of these devices are also used as personal communication devices, enabling phone, text, picture, and video communication with other similar portable devices. Many of these devices include touch screens, tilt interfaces, voice recognition, and other modern user input modes. As a result, the general social trend within industrial societies is that every person does now or soon will maintain at least one such multi-purpose electronic device upon their person at most times, especially when out and about.

While such devices allow accessing information and person to person communication, they do not provide any unique tools and infrastructure that specifically enable groups of electronically networked individuals to have a real-time group-wise experience that evokes the group's collaborative intent and intelligence (Collaborative Consciousness). Hence, there is a substantial need to provide tools and methods by which groups of individuals, each having a portable computing device upon their person, to more easily contribute their personal will/intent to an emerging collaborative consciousness, allowing the group to collectively answer questions or otherwise express their groupwise will in real-time. Furthermore, there is a need to provide tools and methods that enable groups of users to be informed of the group-wise will that is emerging in real-time. The present invention, as described herein, addresses these and other deficiencies present in the art.

### SUMMARY OF THE INVENTION

Several embodiments of the invention advantageously address the needs above as well as other needs by providing a multi-level, real-time collaborative system comprising: a plurality of computing devices each comprising a communications infrastructure coupled to each of a processor, a memory, a timing circuit, and a display interface coupled to a display and configured to receive input from a user, each computing device further comprising a collaborative intent application in communication with a collaboration server running collaboration software, wherein the collaborative intent application of each computing device is configured to repeatedly in real-time receive user input from the computing device and communicate it to the collaboration server, and in response receive a group intent derived, by the collaboration software, from the user input from each of the plurality of computing devices; wherein the plurality of computing devices further comprises a first group receiving a first prompt from the collaboration server and a second group receiving a second prompt from the collaboration server; and wherein the collaboration server repeatedly receives first group user inputs and send first group group intents to the first group, the collaboration server also repeatedly receiving second group user inputs and sending second group group intents to the second group, whereby the first group group intents result in a first group response to the first prompt and the second group group intents result in a second group response to the second prompt.

In another embodiment, the invention can be characterized as a multi-level, real-time collaboration control system comprising: a plurality of computing devices each comprising a communications infrastructure coupled to each of a processor, a memory, a timing circuit, and a display interface coupled to a display and configured to receive input from a user, each computing device further comprising a collaborative intent application in communication with a collaboration server running collaboration software, wherein the collaborative intent application is configured to repeatedly in real-time receive user input from the computing device and communicate it to the collaboration server, and in response receive a group intent derived, by the collaboration software, from the user input from each of the plurality of computing devices; wherein the plurality of computing devices further comprises a first group and a second group, wherein the first group further comprises a plurality of first subgroups, wherein each of the first subgroups repeatedly provides user inputs in response to a prompt, whereby the user inputs results in each subgroup choosing a target; and wherein the second group receives each of the targets.

In yet another embodiment, the invention may be characterized as a distributed architecture, real-time collaborative system comprising: a plurality of computing devices each comprising a communications infrastructure coupled to each of a processor, a memory, a timing circuit, and a display interface coupled to a display and configured to receive input from a user, each computing device further comprising a collaborative intent application; wherein the plurality of computing devices are divided into a plurality of device groups, each device group comprised of a plurality of computing devices, wherein each device group includes one host device and a plurality of client devices, the host device running collaboration software and in communication with at least one different device group and in communication with the client devices of the device group, the host device running the collaboration software configured to receive user input from each collaborative intent application of the device group and determine a group intent from the user input, the host device further configured to send the group intent to the collaborative intent applications of the device group and to the at least one different device group, wherein the collaborative intent application of each computing device is configured to repeatedly in real-time receive user input from the computing device and communicate it to the host device.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic diagram of the collaborative system in accordance with the prior art.

FIG. 2 is a schematic diagram of a multi-group collaborative system in accordance with one embodiment of the present invention.

FIG. 3 is a diagram illustrating a dynamic pointer in accordance with one embodiment of the present invention.

FIG. 4 is a schematic diagram of the multi-group collaborative system in accordance with another embodiment of the invention.

FIG. 5 is a view of an embodiment of a target board display of the multi-group collaborative system.

FIG. 6 is a view of another embodiment of a target board display of the multi-group collaborative system.

FIG. 7 is a schematic diagram of a computing device triad as used in a multi-tier collaborative system embodiment of the present invention.

FIG. 8 is a schematic diagram of the multi-tier collaborative system.

FIG. 9 is a flowchart diagram of a process of the multi-tier collaborative system.

FIG. 10 is a schematic diagram of the distributed architecture multi-tier collaborative system.

FIG. 11 is a view of an embodiment of a target board display as used for rating of a response.

FIG. 12 is a flowchart diagram of a process for providing a rating in accordance with one embodiment of the present invention.

FIG. 13 is a view of a further embodiment of a target board display as used for rating of a response.

FIG. 14 is a flowchart diagram of a process for providing a rating in accordance with another embodiment of the present invention

FIG. 15 is a diagram illustrating a color-changing pointer in accordance with one embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

As referred to in this specification, “media items” refers to video, audio, streaming and any combination thereof. In addition, the audio subsystem is envisioned to optionally include features such as graphic equalization, volume, balance, fading, base and treble controls, surround sound emulation, and noise reduction. One skilled in the relevant art will appreciate that the above cited list of file formats is not intended to be all inclusive.

Real-time occurrences as referenced herein are those that are substantially current within the context of human perception and reaction.

### PRIOR ART

As described in related patent application Ser. No. 14/668,970, the massive connectivity provided by the Internet is used to create a real-time closed-loop collaborative consciousness (or emergent group-wise intelligence) by collecting real-time input from large numbers of people through a novel user interface and processing the collected input from that large number of users into a singular group intent that can answer questions or otherwise take actions or convey will in real-time. The methods use intervening software and hardware to moderate the process, closing the loop around the disparate input from each of the many individual participants and the singular output of the group. In one embodiment, each individual user (“participant”) engages the user interface on a portable computing device 104, conveying his or her individual real-time will in a response to a prompt such as a textually displayed (or audibly displayed) question as well as in response to real-time feedback provided to the user of the group's emerging real-time intent. This closes the loop around each user, for he is conveying individual intent while also reacting to the group's emerging intent. Thus each user must be able to see not only the prompt that begins a session, but the real-time group intent as it is forming. For example, if the intent is being conveyed as words, the user will see those words form, letter by letter. If the intent is being conveyed as a direction, the user sees the direction form, degree by degree. If the intent is being conveyed as a choice among objects, the user sees a graphical pointer get closer and closer to a particular chosen object. The pointer may be, for example, as shown below, a dynamic pointer 300, an exemplary pointer 508, or a color changing pointer 1506. Other embodiments as shown in related applications are also possible.

Thus, the user is seeing the group's will emerge before his eyes, reacting to that will in real-time, and thus contributing to it. This closes the loop, not just around one user, but around all users who have a similar experience on their own individual computing device 104. While the embodiments described generally refer to portable computing devices 104, it will be understood that non-portable computing devices, such as desktop computers, may also be used.

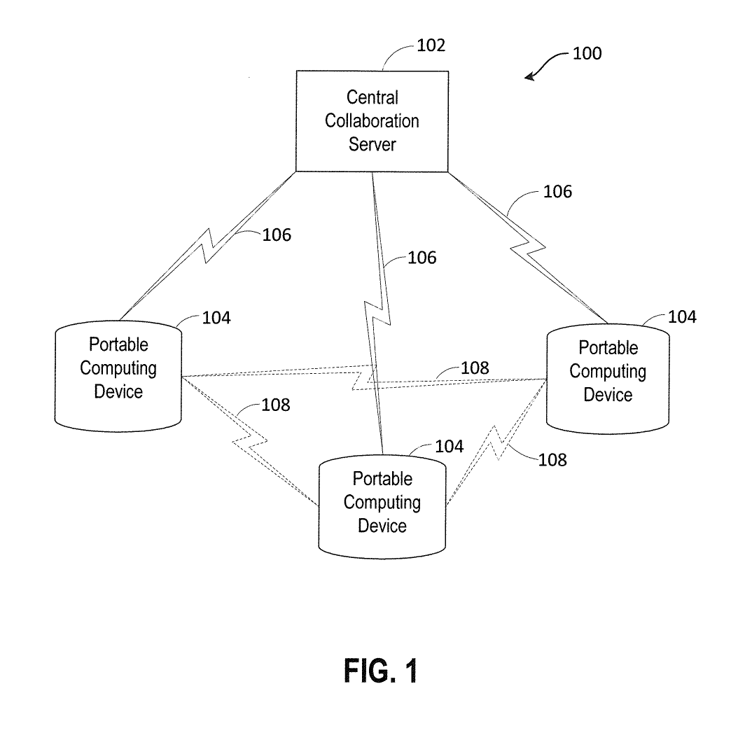

A collaborative system has been developed that allows a group of users to collaboratively control the graphical pointer in order to collaboratively answer questions or otherwise respond to prompts. Referring next to FIG. 1, a schematic diagram of an exemplary collaborative system 100 is shown. Shown are a Central Collaboration Server 102, a plurality of portable computing devices 104, a plurality of exchanges of data with the Central Collaboration Server 102, and a plurality of exchanges of data between portable computing devices 108.

The plurality of portable computing devices 104 in one embodiment are as previously disclosed in the related patent application Ser. No. 14/668,970.

The collaborative system 100 comprises the Central Collaboration Server (CCS) 102 that is in communication with the plurality of portable computing devices 104, each portable computing device 104 running a Collaborative Intent Application (CIA), such that the plurality of individual users, each user interacting with one of the plurality of computing devices 104, can provide user input representing a user intent (i.e. the will of the user). The plurality of user inputs is numerically combined to result in a group intent, thus enabling collaborative control of the pointer that is manipulated by the group intent to select a target from a group of elements (input choices) and thereby form collaborative responses. The portable computing devices 104 are in communication with the CCS 102 as shown by the data exchanges 106. In some embodiments, such as the architecture shown below, the portable computing devices 104 may communicate with each other, as shown by the exchanges of data 108 between portable computing devices 104. The CCS includes software and additional elements as necessary to perform the required functions. In this application, it will be understood that the term “CCS” may be used to refer to the software of the CCS or other elements of the CCS that are performing the given function.

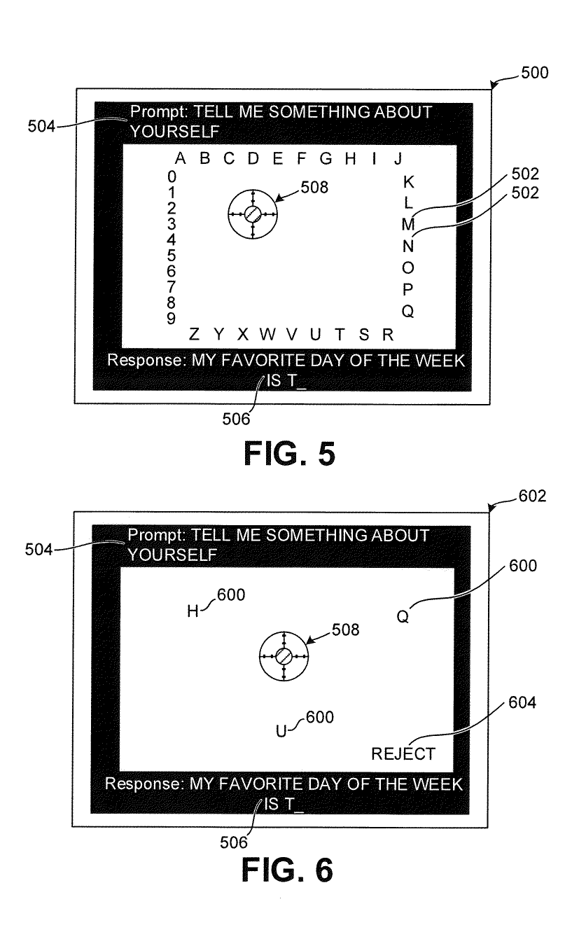

As disclosed in related patent application Ser. No. 14/668,970, in one embodiment each user views a target board on a display of his portable computing device 104. Exemplary target boards 500, 602, 1100, 1300 are shown below in FIGS. 5, 6, 11 and 13. The display of the target board is enabled by the CIA of the device 104. In some embodiments the target board comprises the plurality of input choices (e.g. letters, numbers, words, etc.) that can be selected to form the response to the posed query.

In another embodiment, also displayed on the target board is the graphical pointer 508 that selectively moves in relation to the input choices displayed on the target board, said motion executed in response to the group intent input of the plurality of users. By collaboratively moving the pointer, said plurality of users is enabled to sequentially select the target from the input choices of the target board and thereby produce the collaborative response to the posed query or prompt. In some embodiments, the selection is made when the pointer is positioned on or near the input choice for more than a threshold amount of time. When the target is selected it is added to the emerging answer.

More specifically, embodiments of the current system 100 enable each of the plurality of users to view on their own portable computing device 104, the graphical pointer and the target board, and enable each of said users to convey the user intent as to the desired direction (and optionally magnitude) of motion the user wants the pointer to move so as to select the input choice on the target board.

The user input is typically represented as a user intent vector, including both a direction and magnitude of the user input. The user intent vector can be input by the user, for example, by tilting his or her computing device 104 in the desired direction. In other embodiments the user intent vector is input by swiping on a touchscreen. The user intent vector is communicated by the CIA running on the user's portable computing device 104, to the Central Collaboration Server (CCS) 102.

The CCS 102 receives the user intent vectors from the plurality of users via a network, and then derives a group intent vector that represents the collective will of the group at that time.

The group intent vector is then used to compute an updated location of the pointer 508 with respect to the target board and input choices, the updated location reflecting the collective will of the group.

The updated pointer location is then sent to each of the plurality of computing devices 104 over the network and is used by the CIA software running on said computing devices 104 to update the displayed location of the pointer. The result is that each of the plurality of users can watch the pointer move, not based on their own individual input, but based on the overall collective intent of the group.

The group intent vector can be computed from the plurality of user intent vectors as a simple average, or may be computed as a weighted average in which some users have more influence on the resulting collective intent than other users. The weighting of each user can be derived based on user scores earned during prior interactions with the system 100. In such embodiments, each user may be assigned one or more variables that represent how his or her input should be weighted with respect to other users. In some embodiments the variable is a user contribution index and is updated regularly to reflect the demonstrated skill of that user in providing input that helps the group craft the coherent collaborative response. The user who has demonstrated a history of “constructive input” (i.e. input that is substantially aligned with the group intent, will be assigned a higher user contribution index than a user who has demonstrated a history of “destructive input” (i.e. input that is substantially opposing the group intent. In this way, users may be incentivized to push for collaborative consensus.

### Synchronicity Value

In one embodiment of the present invention, the computer mediating systems described herein can be viewed as enabling a real-time negotiation among the plurality of users, each providing input to convey his or her individual user intent, while viewing an output that represents the group's collective intent. A skilled user is one who is able to convey his personal will, but do so in a cooperative manner that is supportive to the emerging consensus that drives the collective intent. As disclosed herein, a user who is supportive to the emerging consensus is referred to as convergent. This can be determined computationally by comparing each user's user intent vector with the group intent vector.

The more aligned the instant user intent vector is with the instant group intent vector, the more convergent that user is being at that moment. The more opposed the instant user intent vector is from the direction of the instant group intent vector, the more divergent the user is being at the moment. This level of convergence or divergence is hereby represented by a synchronicity value (also referred to as a synchrony value).

In some embodiments, each user's synchronicity value has a range of +1 to −1, with the value +1 being assigned when the user intent vector is substantially aligned with the group intent vector, and with the value of −1 being assigned when the user intent vector is substantially in the opposite direction of the group intent vector, with all values between +1 and −1 being used to represent varying degrees of alignment. For example, if at a given moment the user intent vector is 90 degrees out phase with the group intent vector, a value of 0 is assigned, for that is halfway between fully convergent and fully divergent. Thus, the skilled user is one who is able to convey his individual intent as input, but do so in a cooperative manner. Such a user will maintain a positive synchronicity value during much of the session, for he is being supportive of the group intent. A user who maintains a positive value may be awarded more points and be assigned a higher user contribution index than a user who does not.

### Multi-Group System

A powerful feature of the current invention comprises computer mediated methods for enabling multiple groups of users to be defined and maintained, each of said groups comprising a cooperative collective that operates as a unit, substantially independent of the other of said groups. In this way, a plurality of cooperative collective groups of users can be formed and moderated to function as independent “collaborative consciousnesses” that answer questions, ask questions, rate responses, or otherwise take group actions as described herein. In such embodiments, the Central Collaboration Server (CCS) 102 is configured to spawn, maintain, and moderate a plurality of collaborative user groups, each group being assigned a unique group identifier that is linked to each of the plurality of individual users who comprise that group.

The methods and systems disclosed herein are primarily directed towards either (a) increasing the coherence of the group response by dividing the users into two or more groups, and (b) enabling a multi-tier parallel processing architecture that can improve the efficiency and capacity of the overall collaborative intelligence.

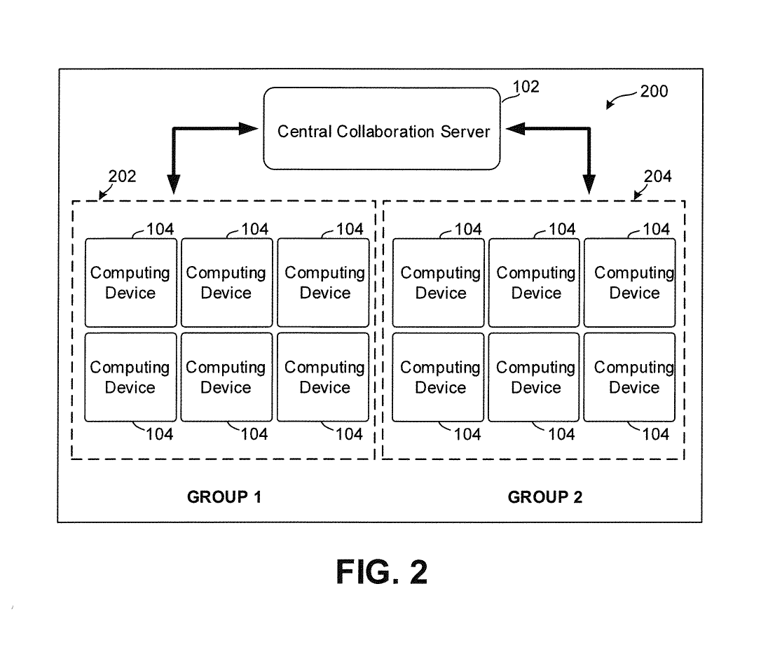

Referring next to FIG. 2, a schematic diagram of a multi-group collaborative system 200 is shown in accordance with one embodiment of the present invention. Shown are the CCS 102, the plurality of computing devices 104, a first group of computing devices 202, and a second group of computing devices 204.

The multi-group collaborative system 200 is generally similar to the system 100 shown in FIG. 1, with the exception that each computing device 104 is assigned to one of the two groups 202, 204. The groups 202, 204 communicate with the CCS 102 independently of each other. Each group communicates with the CCS 102 as previously described in FIG. 1. In accordance with the embodiments previously described, there is a first group of users using the first group of computing devices 202, and a second group of users using the second group of computing devices 204.

The multi-group collaborative system 200 comprises the plurality of portable computing devices 104, each device 104 running the Collaborative Intent Application (CIA), as described herein and in related patent application Ser. No. 14/668,970. In the configuration shown in FIG. 2, the portable computing devices 104 are divided into two groups: the first group 202 and the second group 204. In the embodiment shown, each device 104 belongs to only one group. Each device group 202, 204 (also referred to as a “group” or a “collective”) is assigned a unique group identifier and is in communication with the CCS 102 running the central collaboration software. The communication between the CCS 102 and the device groups 202, 204 includes exchanges of data 106. Communication of each group 202, 204 with the CCS 102 is described further below.

Using the multi-group architecture, the plurality of groups 202, 204 can be moderated simultaneously, allowing a variety of powerful new functions and features. For example, CCS software can be configured to moderate device groups 202, 204 that are enabled to compete against each other in tasks (group vs group, not user vs user). To foster such group-wise competition, the CCS 102 can be configured to maintain one or more group scores associated with each device group 202, 204, said group score being viewable by the users who are participating. In this way, collaborative groups can be formed, uniquely identified, and compete among each other for top rankings on one or more software assessed group score values.

In the embodiment shown in FIG. 2, two groups are shown for simplicity, but it will be understood that any number of groups may be formed from the plurality of computing devices 104.

In some embodiments, a group speed score is assigned to each device group 202, 204, the group speed score reflecting how quickly the group of users has collaboratively responded to one or more previous prompts.

In some embodiments, a group coherence score is assigned to each group 202, 204, the group coherence score reflecting a group coherence level of collaboratively generated responses to one or more previous prompts.

In some embodiments, a group cohesiveness score is assigned to each group 202, 204, the group cohesiveness score reflecting how synchronous the group has been during the generation of one or more collaborative responses to prompts. In the context of the present invention, a “synchronous” group is defined as the group where members work substantially cooperatively with one another to move the pointer rather than work substantially in opposition with one another. Within this context, a low synchronous group is one that falls often into a stalemate, the pointer not moving at all, or jittering back and forth, because the sum of the input from its users cancels out, resulting in a group intent vector that is at or near a 0 value (either instantaneously 0, or averages to 0 over a period of time). Conversely, a highly synchronous group is one that has the pointer move at or near its maximum speed for substantial portions of a session, for the sum of all the input is additive rather than canceling, resulting in a group intent vector that is at or near a maximal value.

Thus, one novel method of generating the group cohesiveness score is to compute a running average of the absolute value (i.e. magnitude) of the group intent vector over time. If the running average is determined to be low (or zero), the group is assigned a low group cohesiveness score. Conversely, if the running average is high (approaching a maximum allowable value), the group is assigned a high group cohesiveness score. In other embodiments, instead of the running average, a numerical integration over time is performed, for the integral of the magnitude of the group intent vector, over a period of time, is reflective of group cohesiveness.

In some embodiments, multiple scores are used in combination to generate an overall group score. In some instances the group may be highly cohesive (i.e. work very collaboratively), but the group efforts could yield responses that are not highly coherent. Similarly, the group may produce highly coherent responses, but take a very long time to generate those responses, thus being less effective than other groups that may be slightly less coherent, but work much faster as a collaborative unit. Thus the overall group score may be generated by the CCS 102, the overall score being a function of multiple assessed values, such as the group speed score, the group coherence score, and the group cohesiveness score.

In some embodiments, the first group 202 produces a first response to a first prompt. The second group 204 receives an indication of the first prompt received by the first group 202 and also the first response. The second group 204 selects the second response from the input choices, one input choice being the first response. In other embodiments, the first group 202 is divided into a plurality of subgroups. Each subgroup provides one response to the first prompt. Each subgroup response is then included in the input choices displayed to the second group 204.

In some embodiments of the present invention, the CCS 102 is configured to assemble the groups 202, 204 from a plurality of users who request participation. The users make the request by logging into the CCS 102 from a remote terminal (which can be their computing device 104). When logging into the CCS 102, the user sets up an account for the collaborative system 200, selecting a unique user name and password. The CCS 102 then maintains data about that user, including the unique address of their computing device 104, personal demographic information, usage history data that is collected over time, including user scoring data as described previously. These may include user contribution index and user synchronicity values. Using at least a portion of this data, the CCS 102 assigns the user to one of a plurality of collaborative groups 202, 204. Each of said collaborative groups is assigned the unique group identifier, as described previously. Thus when member is assigned to one group, his unique user identifier is linked to that group's unique group identifier. The CCS software may fill up groups in a simple method as new users join, where groups have a maximum size, and when one group is full, an additional group is spawned. Alternately, the CCS software may assign groups using more intelligent methods. Two such intelligent methods of group creation are described herein as follows (a) demographically assigned group and (b) score assigned groups.

For demographically assigned groups the CCS software uses demographic characteristics that are entered by a user when signing up for a collaborative system account, to assign groups. In some such embodiments, the groups are assigned to achieve a desired mix of various demographic characteristics. In some such embodiments, the CCS software uses gender when assigning users to groups, attempting to achieve as even a mix as possible of male and female members across the plurality of groups. In other embodiments, the CCS 102 uses age when assigning groups, attempting to achieve an even distribution of age ranges across the plurality of groups. In other such embodiments, the CCS 102 uses highest level of education when assigning groups, for example to achieve an even distribution of educational levels across the plurality of groups. In other such embodiments, the CCS software uses location of residence when assigning groups, for example to achieve an even distribution of residential locations across a plurality of groups. In other such embodiments, the CCS software uses marital status, occupation, and/or political affiliation when assigning groups, for example to maximize the evenness of distribution of married and unmarried users, Democrat and Republican users, or even maximize the evenness of distribution of users who work in various fields of occupation when assigning groups. By creating groups with these types of demographical even distributions, the groups will be more balanced when they compete with each other, and/or when they rate each other.

In other embodiments, demographic characteristics are not used to create even distributions, but to create groups with very specific leanings. For example, the CCS software can be configured to assign groups such that a group is filled only with members who are identified with a particular political party, school affiliation, team fandom affiliation, music group fandom affiliation, age range, location of residence, marital status, or gender. In this way the group filled only with members who identify as Democrats can be assigned and compete with the group that is filled only with members who identify as Republicans. Such a split allows for entertaining competition among the groups, with those self-identified Democrats competing as a collaborative intelligence against groups whose members identify as Republicans. Alternately, such a split allows for collective dialog between groups, thus enabling a collective consciousness composed of democratic members to hold a conversation with a collective consciousness composed of republican members.

Using these same techniques a competition and/or conversation can be enabled between groups that are defined based on other characteristics. For example, the group that is all male may be defined and enabled to compete or converse with the group that is all female. Similarly, the group with users all from a certain locative area (e.g. the users all live in the state of New York) can be defined and enabled to compete or converse with the group that is composed of members living in a different locative area (e.g. California). In this way, the State of California can hold a collaborative conversation (or competition) with the state of New York. Or the country of Russia can hold a collaborative conversation (or competition) with the country of America. Fandom is also a powerful demographic quality for assembling collectives, enabling a group of Raiders fans to be assembled into the group such that they can hold a collaborative conversation or collaborative competition with the group assembled from 49ers fans. Similarly, the CCS software can use this powerful function to enable Star Wars fans to be assembled into the group such that they can hold a collaborative conversation or collaborative competition with the group assembled from Star Trek fans.

In some embodiments of the present invention, the CCS software and CIA software are configured to give new users a personality questionnaire such that users can be quantified based on one or more personality characteristics. For example, a Myers-Briggs personality test can be administered to new users, thereby enabling them to be categorized by personality characteristic. The CCS software may then be configured to assemble groups in a manner that attempts to achieve the most even distribution of personality types in each collective. For example, users who are assessed to be extroverts can be evenly distributed in groups with respect to users who are assessed to be introverts. In other embodiments, the CCS software may be configured to assembled groups by personality type, grouping together members who share one or more personality characteristic. For example, members who are designated as extroverts can be grouped together, able to compete against or converse with introverts. The same can be done for other of the Myers-Briggs designations (thinking vs. feeling, judging vs. perceiving, and sensing vs. intuition). Similarly, an IQ test can be administered to users and groups can be assembled by the CCS software either to achieve even distributions of IQ across groups, or to assemble collectives by grouping members of similar IQ level. In some embodiments IQ and personality are used in combination by the CCS software to assemble groups.

In some embodiments, the CCS 102 can be configured to assign users to groups based on the scores the user has earned during previous sessions. For example, users may be split into skill levels on a scale between novice and expert, based on earned scores such as user contribution index values and user synchronicity values. In some embodiments, users who fall into the same skill level range are grouped into the same group, thus allowing skilled users to be promoted to another group composed of other users who have reached the same skill level. This allows for the evolution of groups, with more skilled members rising through the ranks, being promoted to groups that are filled with other users who have also demonstrated effective performance in collaboration. This also allows for members whose performance drops over time to be demoted down to a group of lower skill level. This also provides users with an incentive to achieve higher scores, thus getting promoted to a more skilled collective. Ultimately, this unique method will allow for the most skilled users to bubble to the top and join together in a collective of high performance collaboration—a super-collective that demonstrates the highest level of collaborative consciousness.

Another feature of the current invention comprises computer mediated methods for enabling users to create, name, and configure a collaborative group themselves. In some such embodiments, a user logs into the Central Collaboration Server 102 from a remote terminal and selects “new collective” from a menu of options. The user is then given the opportunity to give the new collective group. The name might be something informative, e.g. “Raiders fans”. Other users are then able to self-select into that group from a list of group names, thereby joining that group. In some embodiments, the user that creates the group can define demographic characteristics that are required to join the group. For example, the user can define a group called “Deadheads” and define the demographic characteristic of “Grateful Dead Fan” as a requirement of joining the group. Similarly, the user might define the group by naming it “Progressive Programmers” and define two characteristics—progressive political affiliation, and programmer occupational affiliation, as requirements for joining that group. In this way, the user can define the group composed of likeminded individuals across one or more demographic characteristics. This allows for fun competition and/or conversations between groups which have very different personalities. Thus in one example the group composed of high school students can be defined and assembled and enabled to collaboratively converse with the group composed of senior citizens.

The CCS software may also be configured to adjust the membership of groups over time, for example by ejecting users whose performance score falls below a threshold value because those members are not behaving cooperatively with respect to the overall group intent. Alternatively, when the group exceeds a certain size and/or has been in existence for more than a certain amount of time, the CCS software can be configured to split the group into two or more groups, with the CCS software assigning membership to the new groups either (a) at random, (b) by grouping users based on similarity in their response profiles, or (c) by grouping the highest performing members into one of the new groups, and the lowest performing members into another of the new groups. In this way, the group divides, the profiles evolving to promote smarter and smarter collective consciousness to emerge over time. In some such embodiments, the CCS software reshapes groups after a certain amount of time since being formed, such that the top third of performers are put into a new group (based on scoring), the mid third of performers are put into another new group (based on scoring), and the lowest third of performers are ejected.

In some such embodiments, the plurality of groups may complete in a trivia competition wherein each of said groups works as a collaborative intelligence to answer trivia questions that appear on the screen. Further, the present invention is such that multiple of said groups complete with each other to see which collaborative intelligence can answer the trivia question first. In this way, a speed competition is created under computer moderation, not between users but between collaborative entities, each collaborative entity the computer moderated group forming the real-time closed-loop system. The entity that reaches the correct answer first, is the winner for that question in said trivial competition. The number of points awarded is a function of the time taken by the collaborative group to reach an answer.”

### Dynamic Pointer

As described in related patent application Ser. No. 14/668,970, the system 100 can be configured to allow individual users to convey their user intent vector to the device 104 running CIA software by tilting the device 104 in the direction of the desired vector. This said, the graphical motion of the pointer is not based on the tilt of any individual user, but instead is based on the collaborative input as reflected by the group intent vector. For sessions that involve a small number of users, when the user tilts his portable computing device 104 he will see some impact on the motion of the pointer, although muted (or amplified) by the contributions of other users. For sessions, however, that involve large numbers of users (hundreds or thousands or even millions), the user will not see any visible impact on the pointer as a result of his own individual input. Thus the user may tilt his device 104 aggressively, but see no graphical response. Of course, the user's input as represented by the user intent vector is being used as part of the group intent vector, and with so many other users contributing, the contribution of a single user is not visible. Most users prefer to see some direct result of their input, at least informing them that that their input was received. In the case of tilt, this is especially important because the user may not appreciate without seeing a graphical display, the precise direction of their individual user intent vector with respect to the current motion of the pointer as derived from the group intent vector. To address this problem, novel methods have been developed.

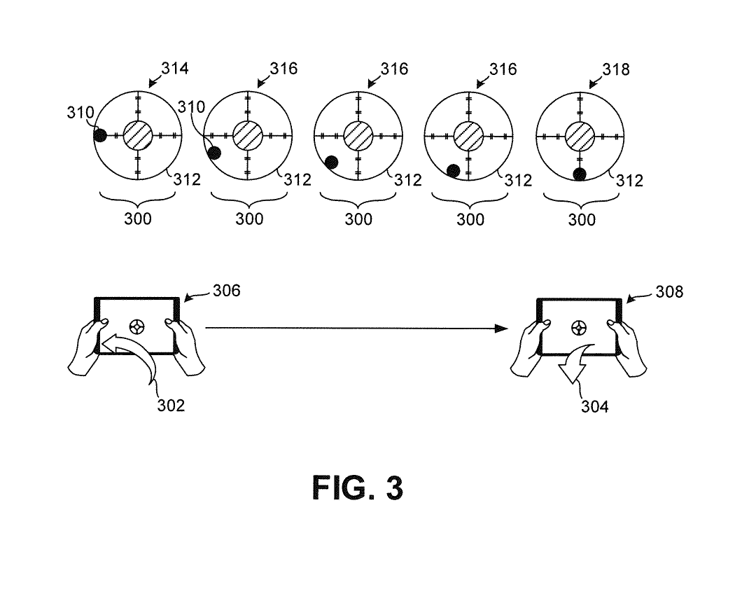

Referring next to FIG. 3, an example of a dynamic pointer implementation is shown. Shown are a plurality of dynamic pointers 300, a leftward tilt arrow 302, a downward tilt arrow 304, a leftward-tilting computing device 306, a downward-tilting computing device 308, a plurality of small indicators 310, a plurality of pointer perimeters 312, a first position 314, and a plurality of intermediate positions 316.

In the dynamic pointer implementation method, the pointer 300 is a circular target shape including an outer perimeter 312 and an inner target. The small indicator 310 is drawn upon the pointer 300 (graphically represented as a metal ball bearing in FIG. 3), the small indicator 310 traveling along within the perimeter 312, displaying to each individual user the substantially current direction of his individual user intent vector.

When the user tilts the screen to the left as shown in the leftward-tilting computing device 306 tilted in the direction of the leftward tilt arrow 302, while the pointer 300 as a whole is moving due to the group intent vector, the small indicator 310 moves relative to the pointer 300 itself. As shown in the first position 314, the indicator 310 has moved to the left side of an inside edge of the pointer perimeter 312, indicating a leftward user input vector.

As the user tilts the display down from the first position, the indicator 310 moves through the intermediate positions. When the display is tilted down, as illustrated by the downward-tilting computing device 308 tilted in the direction of the downward tilt arrow 304, the indicator 310 is located at the bottom of the inside edge the pointer perimeter 312 as shown in the pointer second position 318, indicating a downward input vector.

In the example shown, the indicator 310 is graphically represented as the metal ball bearing, which rolls along the inside perimeter edge 312 of the pointer 300, based on the tilt of the individual user's portable computing device 104. This is a very intuitive way to represent the user intent vector, for it follows a gravitational metaphor that directly reflects that actual physical tilt of the device 104. Thus no explanation is needed for the user—he intuitively understands that the indicator 310 will roll around the inside edge of the pointer perimeter 312 (as if stuck to the edge by a magnet) based on his or her tilting of the pointer 300, thereby showing the user a visual response to the tilt that reflects that individual's personal user intent vector with respect to the pointer 300.

Thus while the pointer 300 is moving in a direction based on the group intent vector, the indicator 310 will point in an independent direction that indicates the individual's user intent vector.

This dynamic pointer method requires configuration of the CIA such that (a) the pointer 300 moves across the target board based on the group intent vector, and (b) the pointer 300 has an adjustable indicator 310 that rides along with the pointer 300, indicating to the user the direction of his or her substantially current user intent vector.

In a physically based model, the indicator 310 represented as the ball bearing can be used to further make the system 100 intuitive from a gravitational perspective. In such embodiments, the ball bearing indicator 310 is assigned a mass, and the path the indicator 310 rolls around is assigned damping. The indicator 310 will roll around based on the individual user's tilt actions, reflecting the mass and damping parameters, as computed by the CIA running on the user's local device 104. The location and magnitude of the mass is conveyed as the user intent vector to the CCS 102. The CCS 102 also receives values from the plurality of group devices 104, each set of values reflecting unique masses (both in location and magnitude). The CCS 102 then sums the masses, and locations, to get a group mass and a group location. This is used to generate the group intent vector. In this way, assigning masses is a convenient way to model the system 100. In fact, each user's unique weighting factor can be presented as his or her mass level, users with higher mass assignments having more impact on the group intent vector than users with lower mass assignments.

### Multi-Level Architecture

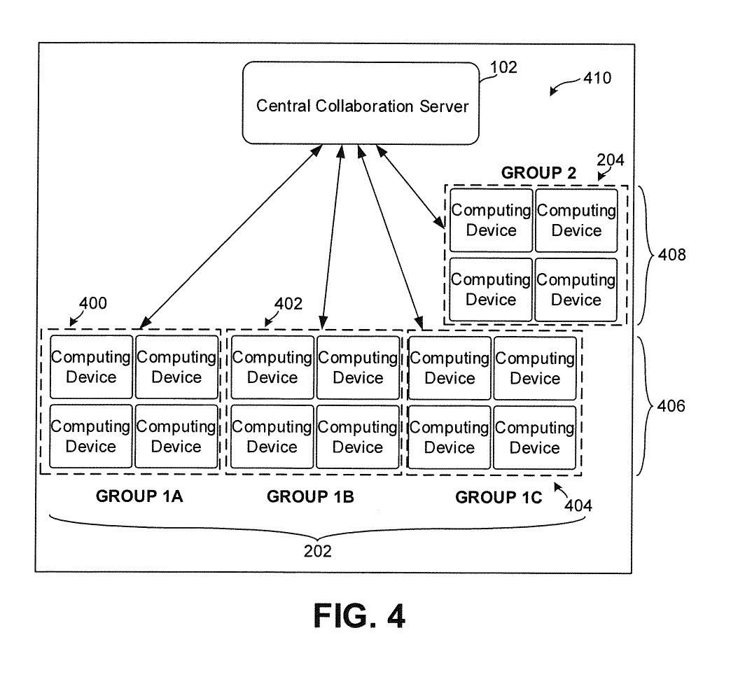

Referring next to FIG. 4, a schematic diagram of a multi-level collaborative system 410 is shown in one embodiment of the present invention. Shown are the CCS 102, the first group of users 202 (also referred to as “the first group”), the second group of users 204 (also referred to as “the second group”), subgroup Group 1A 400, a subgroup group 1B 402, a subgroup Group 1C 404, a first tier Level 1 406, and a second tier Level 2 408.

In the multi-level collaborative system 410, the second group of users 204 directly influences the response of the first group of users 202 (also referred to as “the first group”). The multi-level system 410 also includes a hierarchical structure. One group of users is enabled by the CCS software to directly influence the coherence of the response currently being generated by the first group 202, rather than merely rate the coherence of the response of the first group 202 (as was true of prior methods). This novel multi-level method employs a hierarchical structure in which the first group 202 and the second group 204 work in combination to craft the collaborative response, their efforts coordinated by the CCS 102 software, which arranges the groups into levels 406, 408. While FIG. 4 shows a two-level structure, the method can be extended to structures that employ three or more levels and/or tiers.

An exemplary two-level collaborative system 410 is shown in FIG. 4. The top level (designated, for example, as Level 2) group 408 is identified as Group 2 204. This example includes multiple bottom-level (Level 1 406) subgroups, in this example three subgroups: Group 1A 400, Group 1B 402, and Group 1C 404. Group 1A 400, Group 1B 402 and Group 1B 404 are of the same level (Level 1 406) and are moderated by the CCS 102 software to work in parallel, independently selecting the next target in the emerging answer. These three targets will be three options for the next element to be added to the response, rather than final selections of the next element. These options will be communicated to the higher level (Level 2 408) group, Group 2 204, which will select from the three options. For example, an emerging response at a current moment in time is the phrase—“My favorite day of the week is T_” (as shown in the exemplary response 506 of FIGS. 5 and 6).

The members of all three subgroups of Level 1 408 (Group 1A 400, Group 1B 402, Group 1C 404) control their own group pointer as displayed on their individual computing devices 104. All three of these groups 400, 402, 406 have viewed the emerging answer and are working to pick the next letter to follow. The three groups 400, 402, 406 could select three different letters as their choices for what comes next. For example, Group 1A 400 could select “U”. Group 1B 402 could select “H”. Group 1C 406 could select “Q”. This suggests that Group 1A 400 is thinking the next word should be “Tuesday”. Group 1B 402 is thinking the next word should be “Thursday”. And Group 1C 404 is going down a path of low coherence, for there is no word that has a T followed by a Q.

Using the prior methods as disclosed in related patent application Ser. No. 14/668,970, the Q solution would be resolved because either (a) it would be barred by a spell-check function, or (b) because the second group 204 would provide a low coherence rating in response to the selection of the letter Q. But, the prior methods had no means of addressing the alternate options “U” or “H” since they are not coherence-related. The current multi-level method solves the issue by using Group 2 204 as a second level of collaborative processing, with the users of Group 2 204 enabled by the mediating software to collaboratively select from among the three options generated by the subgroups of Level 1 406.

Referring next to FIG. 5, an exemplary display screen of a user in the Level 1 406 subgroup is shown. Shown are an exemplary pointer 508, an exemplary target board 500, a plurality of Level 1 input choices 502, an exemplary prompt 504, and the emerging exemplary response 506.

In this multi-level embodiment, the users of Group 1A 400, Group 1B 402, and Group 1C 404 each view the target board 500 on their computing devices 104 that (a) allows them to view the latest question or prompt 504, (b) allows them view the emerging response/answer 506, and (c) allows them to provide user input using to select targets from the set of Level 1 input choices 502 displayed on the target board 500.

As shown in FIG. 5, the exemplary prompt/question 504 of the collaborative session is: “Tell me something about yourself” In response to this prompt 504, the users of the three Level 1 subgroups 400, 402, 404 and one Level 2 408 group collaborated to generate the emerging response 506 that so far reads: “My favorite day of the week is T”. At the moment in time shown in FIG. 5, the three Level 1 subgroups 400, 402, 404 are in the process of choosing the next target to be added to the response 506. All members of Group 1A 400 see the same pointer on their screens, Pointer 1A, and work together to collaboratively control it. Similarly, all members of Group 1B 402 see the same pointer on their screens, Pointer 1B, and work together to collaboratively control that pointer. Similarly, all the members of Group 1C 404 see the same pointer on their screens, Pointer 1C, and work together to collaboratively control that pointer. Pointers 1A, 1B and 1C are controlled independently by their respective groups. To enable this, the CCS 102 software is (a) independently moderating the control of Pointer 1A by communicating with Group 1A 400, is (b) independently moderating the control of Pointer 2A by communicating with Group 2A 402, and is (c) independently moderating the control of Pointer 3A by communicating with Group 3A 404, as shown previously in FIG. 4.

In this particular example, the three subgroups 400, 402, 404 select three different targets for the next letters in the answer, as follows: Group 1A 400 selects “U”, Group 1B 402 selects “H”, and Group 1C 404 selects “Q”.

To resolve this discrepancy, Group 2 204 is established at a higher level, its users enabled to view as the Level 2 input choices 600 the three targets that were selected by the three subgroups 400, 402, 404 and select among the targets. In this example, this is achieved by the CIA/CCS software causing the display of the three targets on the collaborative screens of the users of Group 2 204, as shown by the Level 2 input choices 600 shown in FIG. 6.

As shown in a Group 2 target board 602 of FIG. 6, the users of Group 2 204 are given as Level 2 input choices 600 the three options generated by the target selections of the three subgroups of Level 1 400, 402, 404. This allows the users of Group 2 204 to assess which of the three input choices 600 is most responsive, most coherent, and most in line with their collective will. In some instances, none of the three options are deemed desirable. This is why the members of Group 2 204 are also provided with a “REJECT” input choice 604, which, if selected, nullifies the three input choices 600 and requires the three subgroups of Group 1 to each select a new target. In that case the selection repeats at Level 1 406, then giving the users of Level 2 408 a new set of three input choices to select from. Once the users of Group 2 204 select a target from the input choices 600 shown in FIG. 6, the CCS 102 software adds the Group 2 target selection to the emerging response 506, which is then communicated to the computing devices 104 of all users at all levels 406, 408, and is displayed on all screens. The users of Level 1 406 then go on to the next letter to be selected.

As with the other methods disclosed herein, scoring can be implemented as a feedback mechanism, awarding points to those users of a Level 1 subgroup that had their target selected by Group 2 204, and decrementing points from those users of Level 1 subgroups that had their target rejected by Group 2 204. Thus in the example above, if Group 2 204 had selected the letter “H” from the three input choices, the members of the subgroup that provided that option (Group 1B 402) would be awarded points, while the members of the subgroups that provided rejected targets (Group 1A 400 and Group 1C 404) would lose points. Optionally, the point awarding algorithm can also use synchronicity, as described previously, such that only those users who contributed to the selected option are awarded points, while those users who resisted the rejected options may also be awarded points. In this way, feedback is given to all users, which can then be used to adjust the weighting used by the CCS 102 for those users.

In some embodiments, the CCS 102 software limits user participation in higher levels (like Group 2 408) to users who first participate in a lower level subgroup and who achieved above a certain score level. In this way, only skilled users, as demonstrated in their participation in the low level, are promoted to the higher level. This ensures that the higher levels are comprised of skilled members who are fit to provide the higher level processing required of the level, (i.e. making selections among options provided by lower levels). The multi-level method described in the above example uses letters, but the same methods could be used when selecting numbers, symbols, words or other input choices from the target board.

### Distributed Architecture

Thus far in this disclosure, the collaborative system 100 embodiments shown have employed the central server known as the Central Collaboration Server 102, which communicates with the plurality of portable computing devices 104 such as tablets and phones engaged by users. As disclosed in the related patent application Ser. No. 14/668,970, some embodiments allow one of the mobile computing devices 104 engaged by one user to act essentially as the Central Collaboration Server 102, in addition to acting as the portable computing device 104 for that user. In some such embodiments, the CCS 102 software and the CIA software are combined into a single application (“app”) that can be downloaded onto the portable computing devices 104. When using the application, the user selects a “host” option, which turns his or her device 104 into a host device 702 (i.e. acts as the CCS 102), enabling other devices 704 to connect wirelessly to it, those other devices 704 acting as clients. The client devices 704 will act exactly like the portable computing devices 104 described thus far, performing the functions of the CIA software. The host device 702 will perform two functions. First it will act as the CCS 102, coordinating the other client devices 704 by receiving the user intent vectors, computing the resultant group intent vector, and in response sending resulting pointer coordinates to the other client devices 704. Secondly, the host device 702 will act as one of the client devices, running CIA software for the user of that host device 702, thus tracking his user intent vector and treating that vector as if it came from a remote device.

While the above architecture is simple in that it does not require a separate, dedicated server, current technology for portable, mobile computing devices 104 only allow a small number of networked devices to communicate. For example, an iPad® as currently known can only communicate with three other devices at the same time. This would limit the total number of users to 4, with one host device iPad®, and three other users engaging client iPads®. The same is true of iPhones® and other similar devices.

To solve this limitation and expand the number of users that can be employed, without needing a dedicated remote server, the distributed architecture has been devised which allows users to group together in three-device collectives that referred to herein as triads 700. Under the current device limitations, when the host device 702 is communicating with two client devices 704, the host device 702 will still have an open communication channel with which it can communicate with other triads 700. In this way, triads 700 can be connected into a larger network of unlimited size. It will be appreciated that the number of devices 104 in a group may be larger than three, as permitted by the communication capabilities of the devices.

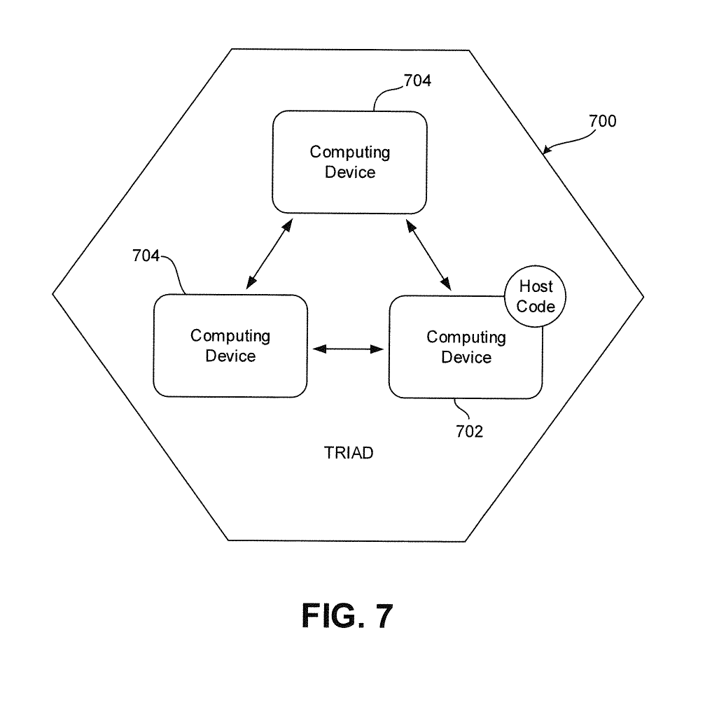

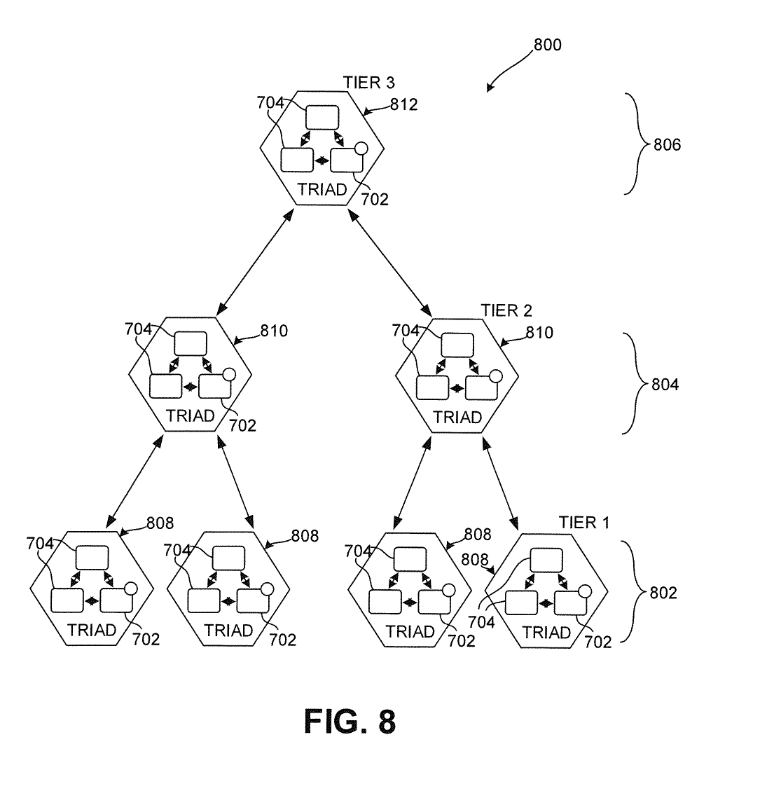

Referring next to FIG. 7, a schematic diagram of a triad 700 of an exemplary distributed architecture collaborative system 800 (as shown below in FIG. 8) is shown. Shown are the triad 700, the host device 702, and two client devices 704.

Each device 104 in the triad 700 is running the distributed version of the Collaborative Interface Application (CIA) software. In the example shown, each device 702, 704 is configured to communicate with up to three other devices 702, 704.

Once the triad 700 has been formed, each of the devices 702, 704 is in communication with the other two devices 702, 704, leaving one free communication channel on each device 702, 704, thus allowing the triad 700 to communicate with up to three other triads 700. By arranging the triads 700 into a unique tiered structure, the present invention allows for a distributed creation of a collaborative intelligence.

Referring next to FIG. 8, a schematic diagram of the three-tier distributed architecture collaborative system 800 is shown. Shown are the plurality of host devices 702, the plurality of client devices 704, Tier 1 802, Tier 2 804, Tier 3 806, a plurality of Tier 1 triads 808, a plurality of Tier 2 triads 810, and a Tier 3 triad 812.

At the bottom level, Tier 1 802, are four Tier 1 triads 808 as described previously in FIG. 7, each comprised of three devices 702, 704. In this embodiment, each of the four Tier 1 triads 808 exchanges data with one of the triads in the tier above (Tier 2 804), sending and receiving the same information that would be passed to the Central Collaboration Server 102. Similarly, each of the two Tier 2 triads 810, exchanges data with the triad in the tier above (Tier 3 806), sending and receiving the same information that would be passed to the Central Collaboration Server 102. In this example, Tier 3 806 is the top tier, so the Tier 3 triad 812 will operate as the final decision maker, but because Tier 3 806 is only receiving information from two other Tier 2 triads 810, the amount of processing is low, much of the computation having already been performed at the lower tiers 808, 810. In this way, the processing load is shared among all the triads 808, 810, 812, rather than all performed by only one host device. While three tiers are shown in FIG. 8, the system 800 may include any number of tiers capable of being supported by the overall system.

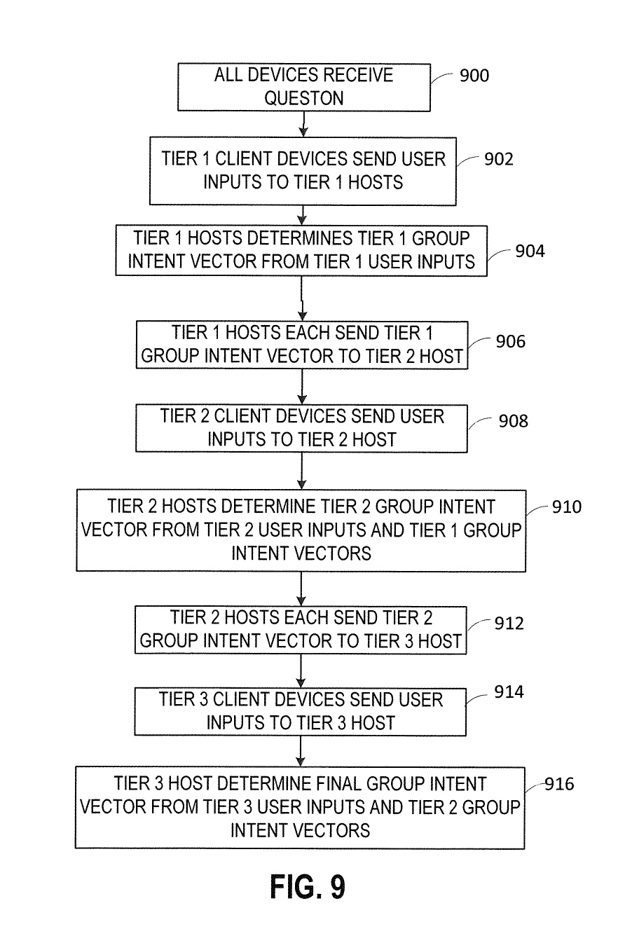

Referring next to FIG. 9, a flowchart diagram of operation of the multi-tier distributed architecture collaborative system 800 is shown. Shown are a receive question step 900, a Level 1 client step 902, a tier 1 group intent step 904, a send tier 1 group intent step 906, a tier 2 client step 908, a tier 2 group intent step 910, a send tier 2 group intent step 912, a tier 3 client step 914, and a tier 3 group intent step 916.

While in this example a three-tier system is shown, the general operation of the system 800 is applicable to systems with any number of tiers.

In the first receive question step 900, all personal computing devices 702, 704 receive the question or prompt from the CCS 102, and display the question on the display. The process then proceeds to the tier 1 client step 902.

Next, in the tier 1 client step 902, each of the tier 1 client devices 704 receives user input and sends the user input to the tier 1 host device 702 of the Tier 1 triad 808. The process then proceeds to the tier 1 group intent step 904.

In the tier 1 group intent step 904, each of the tier 1 host devices 702, having received the user input from the other devices 704 in their Tier 1 triad 808, combines the received user input from the client devices 704 with the user input of the host device 702, and computes the tier 1 group intent vector for that Tier 1 triad 808.

Next, in the send tier 1 group intent step 906, each tier 1 host device 702 sends the tier 1 group intent vector to the tier 2 host 702 that is in communication with that tier 1 triad 808. The process then proceeds to the tier 2 client step 908.

In the tier 2 client step 908, each of the tier 2 client devices 704 receives user input and sends the user input to the tier 2 host device 702 of the Tier 2 triad 810. The process then proceeds to the tier 2 group intent step 910.

In the tier 2 group intent step 910, each of the tier 2 host devices 808, having received the user input from the other devices 704 in their Tier 2 triad 810, and also at least one tier 1 group intent vector, combines the received user inputs with the at least one tier 1 group intent and with the user input of the tier 2 host device 702, and computes the tier 2 group intent vector for that Tier 2 triad 810.

In the send tier 2 group intent step 912, each tier 2 host device sends the tier 2 group intent vector to the tier 3 host 702 (as tier 3 806 is the highest tier in this example, there is only one tier 3 host 702). The process then proceeds to the tier 3 client step 914.

Next, in the tier 3 client step 914, each of the tier 3 client devices 704 receives user input and sends the user input to the tier 3 host device 702. The process then proceeds to the tier 3 group intent step 916.

Finally, in the tier 3 group intent step 916, the tier 3 host device 702 combines the user input of the tier 3 host device, the user inputs of the tier 3 client devices 704, and the tier 2 group intent vectors, and computes a final group intent vector. The final group intent vector can then be distributed down the tiers 802, 804 in a similar manner, with the tier 3 host 702 sending the final group intent vector to the tier 3 client devices 704 and the tier 2 hosts 702, and the tier 2 hosts 702 sending the final group intent vector to the tier 2 client devices 704 and the tier 1 hosts 702, etc., until all devices 702, 704 have received the final group intent vector.

The process then repeats as necessary until the target is reached and/or the response is complete.

In one example of operation of the multi-tier system 800, at a given moment during the current session, all members of Tier 1 802 are viewing the same question, the same partial response, and the pointer at the same location (the pointer coordinates received from the Tier above, i.e. Tier 2 804). All users then tilt their portable computing device 702, 704 to convey the user intent vector. The host of each Tier 1 triad 808 receives the user intent vector from the other devices 704 in its triad 808 and computes from the three user intent vectors, the single Tier 1 group intent vector for that triad 700. Thus if there are four triads 700 in Tier 1 802 as in FIG. 8, four group intent vectors are produced, each passed upward to the connected triad in the next tier (Tier 2 804). On the Tier 2 804 devices, the users are also viewing the same question, the same partial response, and the pointer at the same location as Tier 1 802 (the pointer coordinates received from the Tier above). All those users also tilt their portable computing devices 702, 704 to convey the user intent vector.

The host device 702 of each triad in Tier 2 804 receives the user intent vector from the other client devices 704 in its Tier 2 triad 810, as well as receiving the Tier 1 group intent vector from one or more Tier 1 triads 808 below. In the current example, each of the Tier 2 triads 810 receives the Tier 1 group intent vector from two triads 808 below it at Tier 1 802 and computes from the three Tier 2 user intent vectors and the two Tier 1 group intent vectors, the Tier 2 group intent vector for that Tier 2 triad 810. Thus if there are two triads 810 in Tier 2 804, there are two Tier 2 group intent vectors that are produced, one from each Tier 2 triad 810, each Tier 2 group intent vector passed upward to the next tier (Tier 3 806).

In the example shown, Tier 3 806 is the highest tier, including the single triad 812. Within the Tier 3 triad 812, the users are also viewing the same question, same partial response, and the pointer at the same location as Tier 1 802 and Tier 2 804. All Tier 3 806 users then tilt their computing devices 702, 704 to convey the user intent vector. The host 702 of the Tier 3 triad 812 receives the user intent vector from the other devices 704 in the Tier 3 triad 812, as well as receiving the group intent vectors from the Tier 2 triads 810. In the current example, the Tier 3 triad 812 receives the Tier 2 group intent vector from each of the two Tier 2 triads 810 and computes from the three user intent vectors of Tier 3 and two Tier 2 group intent vectors, the single Tier 3 group intent vector.

Because Tier 3 806 is the top level in this example, the Tier 3 group intent vector produced by the single Tier 3 triad 812 is the system group intent vector for this moment in time. Thus the host 702 of Tier 3 806 performs an extra function not performed by lower tiers 802, 804—it computes the updated location of the pointer 508 based on the final system group intent vector, and passes the updated location (coordinates) to the other computing devices 704 in the Tier 3 triad 812, as well as passing the updated location to the two triads 810 below in Tier 2. The tier 2 triads 810 then pass the updated location to the Tier 1 triads 808. The hosts 702 of all triads pass the coordinates to their client devices 704.

In this way, all computing devices 702, 704 are sent the updated coordinates and use the updated coordinates to display the pointer at a new location. Thus all users are shown the result of the collective will of the whole group and can respond accordingly, by tilting their device 702, 704. This process repeats until it's determined that, in one example, the pointer has targeted an input choice for more than a threshold amount of time. This determination is made by the host at the top of the structure (Tier 3 806), and the input choice is added to the growing response. The letter and/or the full growing response is then passed down through the tiers in the same way the coordinates were, thus allowing all of the individual computing devices 702, 704 in the system to display the updated collaboratively forming response to the users.

In this way, messages are passed up and down the hierarchical structure, with pre-processing happening at each level which handles some of the computations. More specifically, the host 702 of each triad handles the computations related to the user input vectors of the client members 704 of its triad, combined with the group input vector data received from the triad below. The host 702 of each triad can maintain each user's scores, ratings, and demographics. Or each individual device 702, 704 can maintain such data local to its user and pass required info to the host 702 of its triad. In this way, the storage of data can be distributed as well as the computations, allowing for large amounts of data and large numbers of computations to be distributed across many devices 702, 704.

The computation and storage benefits may not be significant in a small system such as the one shown in FIG. 7, for there are only 21 devices 702, 704 working in collaboration, and thus only 21 user intent vectors that need to be numerically combined into the system group intent vector. If, in another example, the system 800 includes 9 tiers, the benefits become clear. In a 9 tier version of this system 800, the number of users expands to 1533, all working in parallel. This means data for 1533 users must be stored (including score data and contribution data, etc.). This also means that the user intent vectors from 1533 computing devices 702, 704 need to be combined into the system group intent vector that affects the pointer location. This is substantial data and substantial computation, but when using the novel distributed structure disclosed herein, no single device needs to handle that amount of data or perform that large a computation. In fact, each individual host device 702 handles no more data and does no more computations than was described with respect to the 3 tier structure.

Hence, the system 800 is expandable to a larger and larger size with the storage and computation load being shared among many devices 702, 704. For example, if the system 800 is expanded to 16 tiers, it can support 196,605 users and still not have any single device 104 have a larger computational burden than the example above. If the system 800 is expanded up to 19 tiers, it can support well over a million users. And by 30 Tiers, the system 800 can support nearly half the people on the planet (over 3 billion), although time-lag through the Tiers of a system that size could be limiting, depending on communication rates and processing speeds.

Some current implementations include 3 to 10 tiers, allowing up to a few thousand users in the single multi-tier distributed architecture collaborative group.

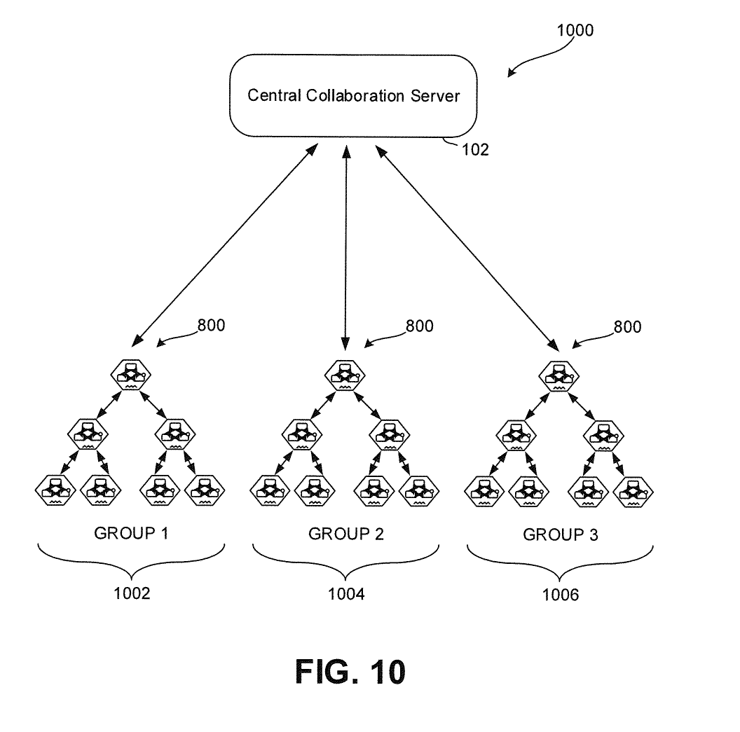

Referring next to FIG. 10, a schematic diagram of a bi-modal embodiment of the multi-tier, distributed architecture system 1000 is shown. Shown are the CCS 102, and a plurality of multi-tier systems 800, the plurality of multi-tier systems 800 including a first multi-tier group 1002, a second multi-tier group 1004, and a third multi-tier group 1006.

In some such embodiments, the Central Collaboration Server 102 is used in combination with distributed architecture collaborative systems 800 to coordinate among multiples of such distributed collectives.

As shown in FIG. 10, the system 1000 can be configured such that the Central Collaboration Server 102 that runs CCS software is used to communicate with the plurality of distinct collaborative groups 1002, 1004, 1006, each of said distinct collaborative groups 1002, 1004, 1006 being moderated using the distributed architecture system 1000. The bi-modal system 1000 allows for the best of both worlds, for the bi-modal system 1000 enables the highly efficient storage and processing afforded by the large number of devices 104 used in parallel by the distributed architecture, while also allowing for the top-down control and oversight afforded by the central server-based architecture.

In the exemplary bi-modal system 1000 shown in FIG. 10, the central collaborative system 1000 is in communication with three multi-tier distributed architecture collective groups: the first multi-tier group 1002, the second multi-tier group 1004, and the third multi-tier group 1006. The Central Collaboration Server 102 maintains a unique identifier and unique data for each multi-tier distributed collective group 1002, 1004, 1006, and communicates with the top tier of each multi-tier distributed collective group 1002, 1004, 1006. This allows for a relatively small amount of data to be communicated between the Central Collaboration Server 102 and each of the multi-tier distributed collective groups 1002, 1004, 1006, while still allowing for all the features and functions described previously, related to groups working in combination and/or in competition.

For example, the Central Collaboration Server 102 could be configured to assign the first multi-tier group 1002 the task of answering the question and/or responding to the prompt, while the second multi-tier group 1004 is assigned the task of rating the coherence of that response, thus enabling feedback between distributed collaborative groups 1002, 1004, 1006 by means of the mediating central server. Similarly, the Central Collaboration Server 102 can be configured to maintain performance scores for each of the distributed collective groups (the first multi-tier group 1002, the second multi-tier group 1004, and the third multi-tier group 1006) and/or demographic characteristic data for each of the collective groups 1002, 1004, 1006.

When employing the CCS 102 to moderate between multi-tier systems 800, said multi-tier systems 800 being internally moderated through the distributed architecture, the CCS 102 can also be configured to allow for adaptive updates of the control routines within the distributed system 800 based on performance among systems 800. More specifically, the CCS 102 may determine that one distributed collaborative system 800 is performing better than another distributed collaborative system 800 based on performance metrics, such as the ones described above (speed, coherence, and cohesiveness), and may modify the structure of the distributed collective system 800 accordingly to optimize performance—for example, increasing or decreasing the number of tiers, modifying the demographic makeup of the users in that system 800, culling the system 800 of low performing members, or splitting the system 800 into multiple smaller groups. In this way, the CCS 102 can act to update the structural parameters and/or control algorithms of the multi-tier distributed systems 800 it moderates so as to optimize the performance of the systems 800. Furthermore, by comparing the performance of multiple systems 800 using different structural parameters and/or control algorithms, the CCS 102 can be configured to assess which structural parameters and/or control algorithms result in better performance, and adjust other groups to match the parameters and/or algorithms of the highly performing systems 800. In this way, competition between systems 800 can be used as an adaptive feedback mechanism that allows the CCS 102 to improve the performance of all systems 800 in the system 1000.

### Coherence Scoring

As previously described in related patent application Ser. No. 14/668,970, the collaborative system 100 is enabled by providing each device 104 with the CIA software that runs on each user's portable computing device 104, each portable computing device 104 in communication with the CCS 102 (or, in the case of distributed architecture, the host device 702). The users are enabled to collaboratively control the pointer that is displayed on the target board in substantial simultaneity on each of the computing devices 104, thereby allowing the group of users to collectively select elements and respond to the displayed prompt/query (i.e. question). In the method as previously described in FIG. 2, two groups of computing devices (and corresponding users) are defined, the first group 202 (Group 1) that collaboratively controls the pointer as described above, and the second group 204 (Group 2) that views the resulting response and collaboratively provides a coherence score.

Coherence Scoring is a computer mediated paradigm used with the multi-group (multi-level) architecture to enable the second group of users 204 to subjectively rate the collaborative response generated by the first group of users 202, the subjective rating conveyed on a scale of coherence. The subjective rating is then used by the CCS software to award points to those users of the first group 202 who contributed to the response, the higher the coherence rating the more points that are awarded. In some embodiments, if the coherence rating produced by the second group 204 is below a certain threshold level, the response is rejected, thereby requiring the first group of users 202 to produce a new response. In general, the coherence rating is performed by the second group of users 204 that is substantially non-overlapping with the first group of users 202, thus creating a two-level structure among the two groups of users 202, 204, with feedback from the second group 204 being used to score the first group 202. In some embodiments the first group 202 and second group 204 do have overlapping members.

The second group of users 204 may be entirely distinct from the first group of users 202, or may have overlapping members with the first group of users 202. The members of the second group 204 also use computing devices 104 that are in communication with the CCS 102, thereby giving them access to the resulting response via communication lines, a representation of the response being displayed on the screen of each of their computing devices 104. The software running on the computing devices 104 of the second group of users 204, enabling this communication and display, may be a version an enhanced version of the prior disclosed CIA software, now enabling a novel multi-level architecture.

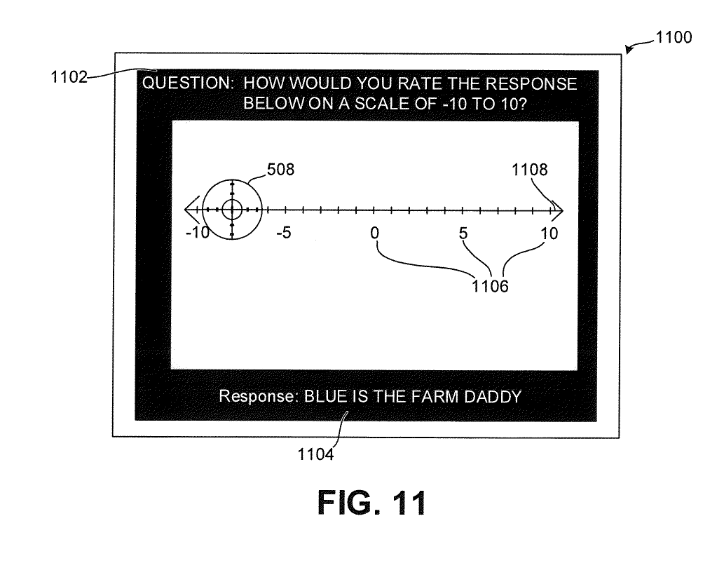

Referring next to FIG. 11, an exemplary target board 1100 is shown as viewed by the second group of users 204 in one embodiment of the session involving coherence scoring. Shown are the Group 2 target board 1100, the pointer 508, the Group 2 prompt 1102, an exemplary Group 1 response 1104, a plurality of Group 2 input choices 1106

As enabled by the CIA, the users of Group 1 202 view the question, query, or other prompt 1102 on the display of their computing devices 104, and then collaboratively respond through the group-wise control of the pointer 508, picking out letters, numbers, words, or other responsive elements, as previously described. The response 1104 appears on the screens of all users (Group 1 202 and Group 2 204). When the response 1104 is complete, the users of Group 2 204 then collaboratively provides the subjective rating of the response 1104 produced by Group 1 202 on a scale of coherence: the coherence rating. A high coherence rating indicates that the response 1104 makes verbal sense. A low coherence rating indicates that the response 1104 is substantially nonsensical. The rating is then used by the software running on the CCS 102 to award points to the users of Group 1 202 who produced the response 1104, the higher the coherence rating the more points that are awarded to the members of Group 1 202. In some embodiments, if the coherence rating produced by the second group 204 is below a certain threshold level, the answer is rejected, thereby requiring the members of Group 1 202 to produce a new response.

In the exemplary session illustrated in FIG. 11, the coherence rating prompt 1102 posed to Group 2 204 is: “How would you rate the response below on a scale from −10 to 10?” This appears at the top of the Group 2 target board 1100, and associated Group 2 input choices 1106 are also shown. These input choices 1106 can be discrete values −10 through 10, or can be a continuous range that is displayed on a number line or other continuous scale 1108 shown in FIG. 11.

As shown in FIG. 11, the prompt 1102 is given to the users of Group 2 204, asking them to rate the coherence of the response 1104 that was generated by Group 1 on a scale of −10 to 10. The response 1104 that Group 1 generated to a question that was posed to them is also shown on the screen: “Blue is the Farm Daddy”. This is an example of a low-coherence response, for the sentence does not make sense.

The target board 1100 appears on the displays of the plurality of computing devices 104 used by the plurality of users of Group 2, each of them viewing the location of the pointer 508 on the graphical number line. The pointer 508 begins at a home position (for example “0” on the number line). The users then convey their individual user input. A variety of methods can be used, as described herein and in related application Ser. No. 14/668,970. In this example, the tilt method is used such that, as the users view the screen on portable computing devices 104, they all tilt their devices 104 to convey the user intent vector as to which way they want the pointer 508 to move on the number-line 1108, as well as indicating magnitude of intent.

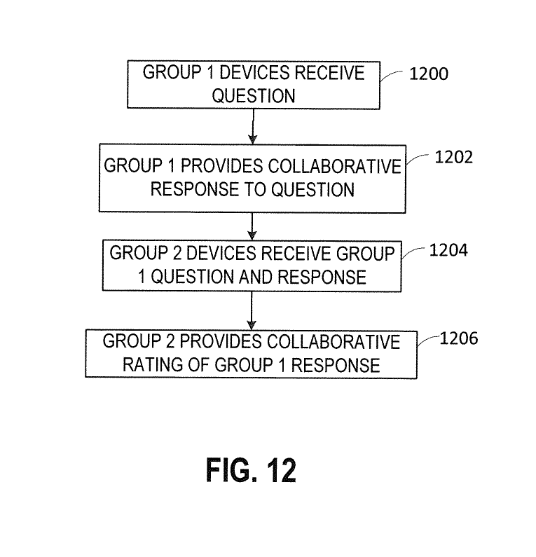

Referring next to FIG. 12, a flowchart diagram of an embodiment of the multi-group rating process is shown. Shown are a receive question step 1200, a provide collaborative response step 1202, a group 2 receive collaborative response 1204, and a group 2 provides collaborative rating 1206.

In the initial receive question step 1200, the Group 1 devices receive the question or prompt 1102 from the CCS 102, which is then displayed for the Group 1 users by the CIA on the Group 1 devices. The process then proceeds to the provide collaborative response step 1202.

In the provide collaborative response step 1202, in accordance with the collaborative systems described herein and in related patent application Ser. No. 14/668,970, the group 1 users repeatedly provide input until the Group 1 collaborative response 1104 to the prompt 1102 is completed.

In the next step, the group 2 receive collaborative response step 1204, the initial question and the Group 1 collaborative response 1104 are sent by the CCS 102 to the Group 2 devices, and the CIA of each Group 2 device displays the question 1102, the response 1104, and the target board 1100 including input choices 1106 for rating the Group 1 response 1104. The process then proceeds to the group 2 provides collaborative rating step 1206.

In the group 2 provides collaborative rating step 1206, the Group 2 users repeatedly provide input until the collaborative rating is completed.

Referring again to FIG. 12, the plurality of user intent vectors are communicated to the CCS 102, which computes the numerical result that reflects the current group intent vector. The as previously described, the group intent vector represents the collective will of the group at that moment in time. Using the group intent vector, the CCS 102 software derives the new location of the pointer 508 with respect to the number line 1108 (as an incremental move on the number line). That new location is communicated to each of the portable computing devices 104, which all update the display of the pointer 508. The pointer 508 is now seen as moving based on the collective will of the group.

This process repeats, with user intent vectors being collected, group intent vectors being computed, and new location coordinates for the pointer 508 being communicated back to the devices 104, the pointer 508 then moving on the individual displays of the computing devices 104, thereby creating a feedback loop. In this way, the users are performing a real-time collaboration/negotiation, to move the pointer 508 on the number line 1108. When the pointer 508 stops moving on the number line 1108 for more than the threshold amount of time, that value is selected as the coherence rating generated collaboratively by Group 2 204. This value is then used by the CCS 102 to award points to the members of Group 1 202.

In some embodiments, the algorithm is set such that the higher coherence rating generated by Group 2 204, the more points awarded to the members of Group 1 202. In this way, Group 2 204 is providing the feedback loop, driving Group 1 202 to be more coherent in order to earn points.

In some embodiments, the scoring algorithm is refined such that the coherence rating generated by Group 2 204 is used by the CCS software in combination with the synchronicity value generated for each member of Group 1 202. More specifically, the scoring algorithm is such that users are awarded points based on both the magnitude of the coherence rating for the current session and the magnitude of a synchronicity value for that user. In this way, the user is awarded the most points if the coherence rating is high for the response, and if the user contributed significantly to the generation of that response as reflected by his high synchronicity value. Conversely, if the coherence rating is high for the session, but a given user's synchronicity value is low, that user loses points, for it means that although the resulting answer was coherent, the user's participation was divergent during the session, meaning the user opposed the creation of the coherent response. Similarly, if the coherence rating is low for the session, meaning the response is incoherent, but a given user's synchronicity value is low, that user is awarded points, for it means that he or she opposed the generation of the incoherent answer. And finally, if the coherence rating is low for a given response, and a given user has high synchronicity value for the session that generated that response, that user will lose points, for it means that an incoherent answer was generated and that user was a contributor to the incoherence.

In this way, users are incentivized by the CCS 102 algorithms to support coherent responses and oppose incoherent responses, which achieves a goal of the invention—to encourage the users of the collaborative group to work together, not simply to produce a collaborative answer, but to produce the collaborative answer that is coherent, thus fostering a genuine collaborative consciousness.

As described in related patent application Ser. No. 14/668,970, the points awarded to the user can be used by the CCS software to adjust the impact that the given user has on future sessions—more heavily weighting the input of users who have high scores (as a result of being strong contributors to coherent answers), and less heavily weighting the input of users who have low scores (as a result of not being strong contributors to coherent answers). In some embodiments, this weighting is stored in a value for each user called a user contribution index, which is updated based on the session the user participates in.

In many embodiments, the CCS 102 stores a database of user contribution index values for the users, the values based on the historical performance of those users. The CCS 102 uses these stored values to more heavily weight the input vectors of users who have a history of contributing positively to coherent answers, and under weighting the input vectors from users who have a history of either opposing coherent answers or contributing to incoherent answers. In some embodiments, the user whose scores are so low that his or her user contribution index falls below a certain threshold is banned from the system 200, thus eliminating outliers. This allows the novel system 200 to optimize itself over time.

The above method demonstrates how the response can be collaboratively generated by the first group of users 202 and how feedback as to the coherence of the response can be collaboratively generated by the second group of users 204. In addition to this, the moderating software of the CIA and CCS 102 can employ a turn-taking method that switches the roles of the members of Group 1 202 and Group 2 204, thus allowing all users to participate in both aspects of the system 200. The turn taking method is described as follows:

Turn Taking (i.e. alternating the roles of Group 1 202 and Group 2 204): In some embodiments, the same CIA software is used on the computing devices 104 of both Group 1 202 and Group 2 204 users, thereby allowing the two groups of users 202, 204 to selectively switch between the roles under easy software control, sometimes being assigned to the group that is answering questions and other times being assigned to the group that is rating the answers produced. In one embodiment, during a first session, the members of Group 1 202 provide the collaborative response while the members of Group 2 204 provide the coherence score of that response. Then, during a next session, the groups switch members, the members of Group 1 202 becoming Group 2 204, and vice versa, such that the users who had just answered the question now provide the coherence score, and the users who had just provided the coherence score now provide the answer to the question.

This is moderated by the CIA and/or CCS 102 software, which are configured to repeatedly switch the assigned groups to keep all users engaged. This is important because for many users, it's more fun to contribute to the response than to be part of the coherence score. It should be noted that an alternative to switching the membership of the groups, is to keep the membership the same and switch the roles of the groups, such that Group 2 204 is assigned the task of providing the response and Group 1 202 is assigned the role of rating the response, the software repeatedly swapping roles of the groups in subsequent sessions.

In some such embodiments, Group 2 204 is also configured to collaboratively provide the question (provide the prompt) to which Group 1 202 responds. After the response is provided, the groups 202, 204 are switched, with the group that had provided the answer now providing the question. By switching back and forth in this way, the collaborative system 200 can be configured to allow the members of one group to have a back and forth exchange of questions and answers, thereby enabling the collaborative conversation between the members of Group 1 202 and Group 2 204. In other words, the system 200 can be configured to allow the members of Group 2 204 to collaboratively ask the question to the members of Group 1 202, which then collaboratively provides the response. Group 2 204 then collaboratively provides a response to the initial response. Group 1 202 then responds, etc. Furthermore, while each group 202, 204 is responding, the alternate group 202, 204 is collaboratively providing coherence scores, thus rating the coherence of the responses.

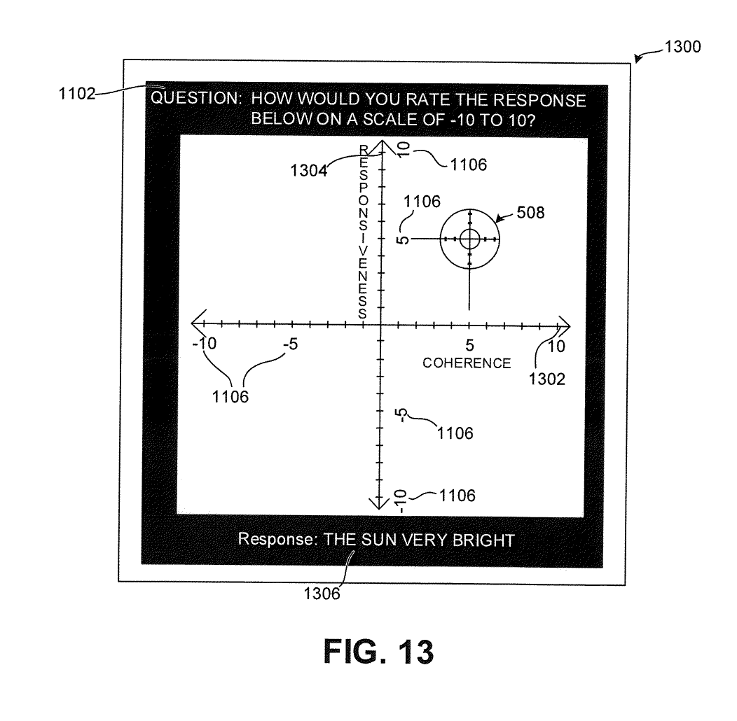

Referring next to FIG. 13, an exemplary two-dimensional coherence rating target board 1300 is shown. Shown are the pointer 508, the exemplary prompt 1102, an exemplary response 1306, the plurality of input choices 1106, an x-axis scale 1302, and a y-axis scale 1304.

As previously described with respect to FIG. 11, the group providing collaborative responses can be enabled by the mediating CIA/CCS software to provide coherence ratings on the one-dimensional scale 1108. In other embodiments, as shown in FIG. 13, a two-dimensional scale comprising the x-axis scale 1302 and the y-axis scale 1304 is enabled by the software, allowing the group that is rating responses to be more expressive in their assessment. In one such embodiment, the two-dimensional scale includes a coherence rating along the x-axis and a responsiveness rating along the y-axis, and the group is rating the response 1306 along both axes 1302, 1304 simultaneously. Coherence is defined herein to mean that the response 1306 is syntactically logical, as opposed to being a string of letters or words that are confusing, meaningless or just plain gibberish.

Of course, the response 1306 could be syntactically coherent but not be particularly responsive to the question or prompt 1102 that was posed to the group (low responsiveness). Or it could be highly responsive even if the syntax is lacking (low coherence).

Thus having these two independent axes 1302, 1304 is a valuable methodology for promoting collectively generated responses that are both coherent in syntax and responsive to the prompt that inspired it.

As shown in FIG. 13, the members of Group 1 202 produced the response 1306: “THE SUN VERY BRIGHT” which is displayed on each of the screens of each of the users who are users of Group 2 204. The users of Group 2 202 then use the novel collaborative control methods described herein to position the pointer 508 with respect to the two axes 1302, 1304, thus rating the response 1306 along two independent metrics.

In a preferred embodiment, the users use portable computing devices 104 with tilt functionality, the CIA software employing novel collaborative tilt methods to move the pointer 508 in two dimensions on the grid. As shown in FIG. 13, the exemplary pointer 508 is positioned at a value of 5 for responsiveness and the value 6 for coherence. This is a positive assessment on both axes 1302, 1304, but not maximal. Thus users of Group 1 202 would likely earn points for such the response 1306, but not maximal points. In this way, a feedback loop is established, encouraging the users of Group 1 202 to aim for collaborative responses that are both highly coherent and highly responsive to the given prompt.

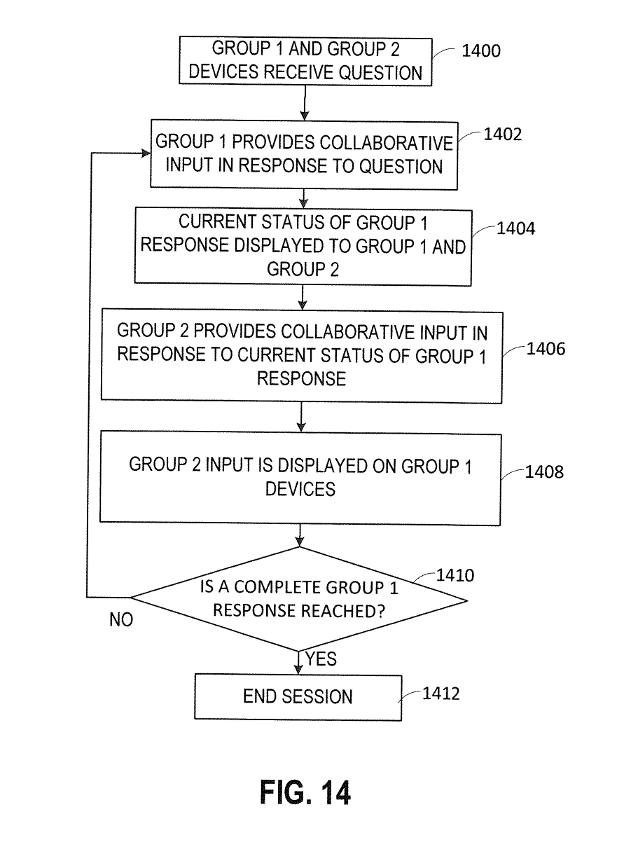

Referring next to FIG. 14, a flowchart diagram of a real-time embodiment of the multi-group rating process is shown. Shown are a groups receive question step 1400, a group 1 input step 1402, a current group 1 status step 1404, a group 2 collaborative input step 1406, a display group 2 input step 1408, a group 1 response complete decision point 1410, and an end session step 1412.

For clarity, the method is described with respect to multi-group system 200 as shown in FIG. 2 (and with response to the exemplary Group 1 202 target board 500 of FIG. 5), but it will be understood that the method may work with any of the suitable embodiments described herein or in related applications.

In the initial groups receive question step 1400, all devices 104, i.e. both Group 1 202 and Group 2 204 devices 104, receive the question or prompt from the CCS 102. The process then proceeds to the next group 1 input step 1402.

In the next group 1 input step 1402, the Group 1 202 users provide input in response to the question/prompt 504. The response 506 is in process, for example, displaying a few letters, but is not complete.

Next, in the current Group 1 status step 1404, the current status of a Group 1 response 506 is displayed to the Group 1 202 users (as previously described) and to the Group 2 204 users, so that the Group 2 204 users have the most recent version of the emerging Group 1 response 504. The process then proceeds to the group 2 collaborative input step 1406.

In the group 2 collaborative input step 1406, the Group 2 204 users, in response to the emerging Group 1 response 506 and using the Group 2 target board displayed on the Group 2 displays, provide input regarding the Group 1 emerging response 506. The process then proceeds to the display group 2 input step 1408.

In the display group 2 input step 1408, the Group 2 204 collaborative input in response to the Group 1 response 506 is displayed on all devices 104.

Next, in the group 1 response complete decision point 1410, if the Group 1 response 506 is complete, the process proceeds to the end session step 1412, and the session ends. If the Group 1 response 506 is not complete, the process returns to the current Group 1 status step 1404, and the Group 1 202 users, having viewed the Group 2 204 input on the Group 1 response 506, can use the Group 2 information in formulating the next iteration of the Group 1 response 506. The process then repeats until the Group 1 response 506 is completed.

Referring again to FIG. 14, in another embodiment of coherence scoring, the real-time method may be used where the second group 204 rates the coherence of the response 506 of the first group 202 in real time. More specifically, in the real-time method, the second group of users 204 is enabled by the mediating software to collaboratively provide coherence scores during the time that the response 506 is still forming under the collaborative control of the first group of users 202. As in the prior method, the score is a subjective rating that's generated collaboratively by the second group of users 204, but in this method the score is continually updated by the second group of users 204 in real-time, as the second group 204 observes the answer 506 being formed by the first group of users 202. This is more efficient than the prior method, since the second group of users 204 may decide that the response 506 generated by the first group of users 202 is becoming incoherent before it is complete. This method is also more informative, for instead of a single rating being generated when the response is complete, the rating is updated repeatedly under collaborative control of the second group of users 204 while the first group 202 is in the process of generating the collaborative response 506.

This real-time coherence scoring method is employed to provide real-time feedback to the members of the first group 202 as they generate the response 506, thereby encouraging them to get back on track if the response 506 is growing less coherent, or encouraging the first group 202 to forge ahead with the answer 506 that is forming coherently.

In preferred embodiments, the coherence scores generated by the users of the second group 204 are used by the CCS software to add points or subtract points to the users of the first group 202. More specifically, the CCS software is configured to award points to those users of the first group 202 who are currently (a) contributing to a coherent answer, and/or (b) resisting an incoherent answer. The CCS software may also be configured to decrement points to those users of the first group 202 who are currently (a) contributing to an incoherent answer, and/or (b) who are resisting a coherent answer.

As described previously, the score assigned to each user can be used to weight the relative impact of the user input on collaborative control. In this way, a novel feedback loop is established that assigns more influence to those users of the first group 202 who are currently contributing to the coherent answer (and/or resisting the incoherent answer), and assigns less influence to those members of the first group 202 who are contributing to the incoherent answer (and/or resisting the coherent answer).

As described previously, the CCS software can also be configured to weight each user's relative contribution to the emerging response 506 by using the synchronicity value assigned to each user. However, the use of the synchronicity value alone does not account for the coherence of the response 506. This could result in users losing points for resisting an errant collaboration, for they are being uncooperative, but justifiably so.

To remedy this problem, in another embodiment a unique bi-modal evaluation method is used that considers the synchronicity values in combination with the real-time coherence. More specifically, the real-time coherence score generated by Group 2 is used by the CCS 102 software in combination with the real-time synchronicity value generated for each user of Group 1 202, to individually score the users of Group 1 202 and adjust their relative weighted contributions the collaborative control of the pointer. In some such embodiments, the algorithm is configured to awards the most points to the user when both (a) the real-time coherence score is high for the response that's currently being formed, and (b) the user is determined to be contributing significantly to the emerging response 506 as reflected by a currently high synchronicity value.

Conversely, if the coherence score is currently high for the response 506 being generated during the ongoing session, but the user's synchronicity value is currently low (i.e. negative), the algorithm awards less points (or subtracts points) from that particular user, for it means that although the response 506 being generated is coherent, the user's participation is currently opposing the will of the group. In other words, that user is resisting the creation of the coherently scored response 506.

Similarly, if the coherence score is currently low for the currently generated response 506, meaning the response 506 has been assessed to be trending incoherent, but a particular user's synchronicity value is also low (i.e. negative), the algorithm running on the CCS 102 awards a high level of points to that user, for it means that he opposed the generation of the incoherent answer.

And finally, if the coherence score is low for the currently generated response 506, and the user has a high synchronicity value for the currently generated response 506, that user will lose points (or be awarded low points), for it means that an incoherent answer is currently being generated and the user is currently a strong contributor to the collaborative incoherence.

In this way, users are individually incentivized to collaboratively support coherent answers and collaboratively oppose incoherent answers, which helps to achieves the objective of the present invention—to encourage the members of the collaborative group to work together, not simply to produce the collaborative answer, but to produce the collaborative answer that is determined to be coherent, thus fostering the genuine collaborative consciousness.

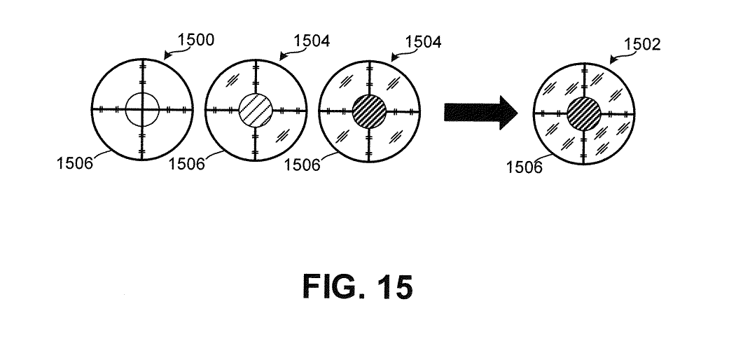

Referring next to FIG. 15, a color-changing pointer embodiment for use in real-time coherence scoring is shown. Shown are a plurality of color-changing pointers 1506, a first color pointer 1500, a second color pointer 1502, and a plurality of intermediate pointers 1504.

In some embodiments, the CIA is configured to provide real-time visual feedback to each of the users of the first group 202, indicating their current performance based on the rating scores from the second group 204 and/or their current synchronicity values. This real-time feedback helps encourage the users of the first group 202 to adjust their behavior based on the scoring from the second group 204. In some such embodiments, the visual feedback is provided by altering the color of the pointer 1506. This allows the user to keep his or her visual attention on the pointer 1506 (and not look elsewhere on the screen of their mobile computing device 104), while providing a clear indication of current performance.

In one such embodiment, users of Group 1 who are currently performing well as determined by the highly scoring combination of coherence score and synchronicity value, are displayed the first color pointer 1500 that is given a first color, for example the color green, by the CIA software running on the computing device 104. Conversely, users of Group 1 202 who are determined to be currently performing poorly as determined by a low scoring combination of coherence score and synchronicity value, are displayed the second color pointer 1502, for example a red-colored pointer. In some such embodiments, a range of hues, from bright green for high-scoring, to bright red for low-scoring, passing through intermediate hues for neutral scoring (for example, yellow hues), is employed by the CIA software. An example of such hue changes, from the green-hued pointer 1500 on the left to the intermediate color pointers 1504, to the red-hued pointer 1502 on the right, is shown with respect to FIG. 11. Other color schemes, a gray-scale scheme, or a patterning scheme, or other changing visual indication could also be used to indicate the user's rating.

While many embodiments are described herein, it is appreciated that this invention can have a range of variations that practice the same basic methods and achieve the novel collaborative capabilities that have been disclosed above. Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A multi-level, real-time collaborative system comprising:
a plurality of computing devices each comprising a communications infrastructure coupled to each of a processor, a memory, a timing circuit, and a display interface coupled to a display and configured to receive input from a user, each computing device further comprising a collaborative intent application in communication with a collaboration server running collaboration software, wherein the collaborative intent application of each computing device is configured to repeatedly in real-time receive user input from the computing device and communicate it to the collaboration server, and in response receive a group intent derived, by the collaboration software, from the user input from the plurality of computing devices;
wherein the plurality of computing devices further comprises a first group receiving a first prompt from the collaboration server and a second group receiving a second prompt from the collaboration server; and
wherein the collaboration server repeatedly receives first group user inputs and send first group group intents to the first group, the collaboration server also repeatedly receiving second group user inputs and sending second group group intents to the second group, whereby the first group group intents result in a first group response to the first prompt and the second group group intents result in a second group response to the second prompt.

2. The multi-level, real-time collaborative system of claim 1, wherein the second prompt is determined based on the first group response.

3. The multi-level, real-time collaborative system of claim 2, wherein the second group response is at least one rating of the first group response.

4. The multi-level, real-time collaborative system of claim 3, wherein the at least one rating is at least one of a coherence rating, an accuracy rating, and a quality rating.

5. The multi-level, real-time collaborative system of claim 2, wherein the collaboration server determines at least one first group score from the second group user inputs.

6. The multi-level, real-time collaborative system of claim 1, wherein the first group group intents are expressed repeatedly in real-time by a first pointer displayed on each display interface of the first group, the first pointer location repeatedly derived from the first group group intents, whereby the first group response is based on the real-time locations of the first pointer, and wherein the second group group intents are expressed repeatedly in real-time by a second pointer displayed on each display interface of the second group, the second pointer location repeatedly derived from the second group group intents, whereby the second group response is based on the real-time locations of the second pointer.

7. The multi-level, real-time collaborative system of claim 6, wherein the second group response is a number selected from a number line displayed on each display interface of the second group.

8. The multi-level, real-time collaborative system of claim 7, wherein the number is selected if the second pointer stops at a corresponding location of the number on the display interface for a threshold period of time.

9. The multi-level, real-time collaborative system of claim 1, wherein constituents of the first group and the second group are determined by the collaboration server.

10. The multi-level, real-time collaborative system of claim 9, wherein the collaboration server selects the constituents of at least one of the first group and the second group based on one of gender, political party, fandom, location, marital status, and school affiliation.

11. The multi-level, real-time collaborative system of claim 1, wherein users of the devices select which group to join.

12. The multi-level, real-time collaborative system of claim 1, wherein the first prompt and second prompt are the same.

13. The multi-level, real-time collaborative system of claim 1, wherein the first prompt and second prompt are provided to the first group and the second group at the same time.

14. The multi-level, real-time collaborative system of claim 1, wherein collaboration server determines an amount of time for each group to reach the response after receiving the prompt.

15. The multi-level, real-time collaborative system of claim 14, wherein a winner group is determined as the group reaching the response in the least amount of time.

16. The multi-level, real-time collaborative system of claim 15, wherein the winner group is awarded a number of points.

17. The multi-level, real-time collaborative system of claim 16, wherein the number of points awarded is based on at least one of time differential between a first group amount of time and a second group amount of time.

18. The multi-level, real-time collaborative system of claim 13, wherein user inputs are used to rate the first group response and the second group response, and the winner group is determined based on comparing the first group response rating to the second group response rating.

19. The multi-level, real-time collaborative system of claim 2, and wherein the second group response is selected from a plurality of input choices, the input choices including the first group response.

20. The multi-level, real-time collaborative system of claim 2, wherein the first group is divided into a plurality of subgroups, each subgroup providing user input in response to the first prompt, whereby a subgroup response is determined for each subgroup, and wherein the second group response is selected from a plurality of input choices, the input choices including the subgroup responses.

21. The multi-level, real-time collaborative system of claim 2, wherein the second group response is one of an acceptance or a rejection of the first group response.

22. A multi-level, real-time collaboration control system comprising:
a plurality of computing devices each comprising a communications infrastructure coupled to each of a processor, a memory, a timing circuit, and a display interface coupled to a display and configured to receive input from a user, each computing device further comprising a collaborative intent application in communication with a collaboration server running collaboration software, wherein the collaborative intent application is configured to repeatedly in real-time receive user input from the computing device and communicate it to the collaboration server, and in response receive a group intent derived, by the collaboration software, from the user input from each of the plurality of computing devices;
wherein the plurality of computing devices further comprises a first group and a second group, wherein the first group further comprises a plurality of first subgroups, wherein each of the first subgroups repeatedly provides user inputs in response to a prompt, whereby the user inputs results in each subgroup choosing a target; and
wherein the second group receives each of the targets.

23. The multi-level, real-time collaboration control system of claim 22, wherein the second group selects a input choice from the received targets

24. The multi-level, real-time collaboration control system of claim 23, wherein the input choice is added to a collective response.

25. The multi-level, real-time collaboration control system of claim 23, wherein in response to the second group selecting the input choice, points are added to members of the subgroup with the target matching the input choice.

26. The multi-level, real-time collaboration control system of claim 23, wherein in response to the second group selecting the input choice, points are subtracted from members of the subgroups with the target not matching the input choice

27. A distributed architecture, real-time collaborative system comprising:
a plurality of computing devices each comprising a communications infrastructure coupled to each of a processor, a memory, a timing circuit, and a display interface coupled to a display and configured to receive input from a user, each computing device further comprising a collaborative intent application;
wherein the plurality of computing devices are divided into a plurality of device groups, each device group comprised of a plurality of computing devices, wherein each device group includes one host device and a plurality of client devices, the host device running collaboration software and in communication with at least one different device group and in communication with the client devices of the device group, the host device running the collaboration software configured to receive user input from each collaborative intent application of the device group and determine a group intent from the user input, the host device further configured to send the group intent to the collaborative intent applications of the device group and to the at least one different device group,
wherein the collaborative intent application of each computing device is configured to repeatedly in real-time receive user input from the computing device and communicate it to the host device.

28. The distributed architecture, real-time collaborative system of claim 27, wherein each device group includes one host device and two client devices.

29. The distributed architecture, real-time collaborative system of claim 27, wherein the device groups are arranged in a multi-tier structure, wherein when a higher tier exists immediately above the device group, the device group communicates with one device group of the higher tier, and when a lower tier exists immediately below the device group, the device group communicates with more than one device group of the lower tier.

30. The distributed architecture, real-time collaborative system of claim 29, wherein each host device is configured to determine a current-tier group intent from the user inputs from the collaborative intent applications of that device group and a plurality of lower-tier group intents received from the more than one device group of the lower tier.

31. The distributed architecture, real-time collaborative system of claim 30, wherein the host device is configured to send the current-tier group intent to a higher-tier device group.

32. The distributed architecture, real-time collaborative system of claim 29 wherein the host device is configured to receive a group intent from a higher-tier device group, the group intent determined from user inputs of the plurality of computing devices.

33. The distributed architecture, real-time collaborative system of claim 29, wherein a highest tier is in communication with a collaboration server running the collaboration software.
